(19) United States
(12) Patent Application Publication
(10) Pub. No.: US 2014/0228372 A1
(43) Pub. Date: Aug. 14, 2014

(54) MICROBIOCIDAL PYRAZOLE DERIVATIVES

(71) Applicants: Clemens Lamberth, Stein (CH); Sarah Sulzer-Mosse, Stein (CH); Fredrik Emil Malcolm Cederbaum, Stein (CH)

(72) Inventors: Clemens Lamberth, Stein (CH); Sarah Sulzer-Mosse, Stein (CH); Fredrik Emil Malcolm Cederbaum, Stein (CH)

(73) Assignee: SYNGENTA PARTICIPATIONS AG, Basel (CH)

(21) Appl. No.: 14/349,721

(22) PCT Filed: Sep. 14, 2012
(86) PCT No.: PCT/EP2012/068043

§ 371 Date: Apr. 23, 2014

(30) Foreign Application Priority Data
Oct. 18, 2011 (EP) 11185567.2

(51) Int. Cl. A01N 43/78; A01N 43/82

(52) U.S. Cl. CPC A01N 43/78; A01N 43/82
USPC 514/249; 546/209; 514/326; 546/193; 514/318; 546/167; 514/314; 544/355; 546/201; 514/323

(57) ABSTRACT

The present invention relates to compounds of formula (I) wherein R₁, R₂, R₃, R₄, R₅, R₆, R₇, R₈, R₉, R₁₀, R₁₁, R₁₂, R₁₃, G₁, G₂, G₃, Y₁, Y₂, n, and p are as defined in the claims. The invention also relates to methods of using the compounds of formula (I) to control or prevent infestation of plants, propagation material thereof, harvested crops or non-living materials by phytopathogenic spoilage microorganisms or organisms potentially harmful to man.

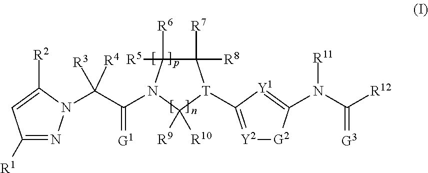

The present invention relates to microbiocidal pyrazole derivatives, e.g. as active ingredients, which have microbiocidal activity, in particular fungicidal activity. The invention also relates to preparation of these pyrazole derivatives, to pyrazole derivatives used as intermediates in the preparation of these pyrazole derivatives, to preparation of these intermediates, to agrochemical compositions which comprise at least one of the pyrazole derivatives, to preparation of these compositions and to use of the pyrazole derivatives or compositions in agriculture or horticulture for controlling or preventing infestation of plants, harvested food crops, seeds or non-living materials by phytopathogenic microorganisms, preferably fungi.

Certain compounds for use as fungicides are described in WO 2007/014290, WO 2008/013622, WO 2008/013925, WO 2008/091580, WO 2008/091594 and WO 2009/055514.

The present invention provides compounds of formula I:

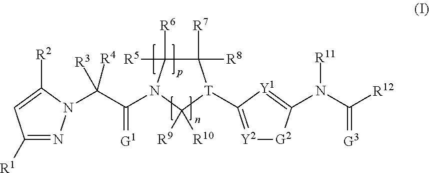

wherein
G¹, G² and G³ are independently O or S;

### T is CR¹³ or N;

Y¹ and Y² are independently CR¹⁴ or N;
n is 1 or 2;
p is 1 or 2, providing that when n is 2, p is 1;
R¹, R², R³, R⁴, R⁵, R⁶, R⁷, R⁸, R⁹, R¹⁰, R¹³ and R¹⁴ each independently are hydrogen, halogen, cyano, C₁-C₄alkyl, C₃-C₅cycloalkyl or C₁-C₄haloalkyl;
R¹¹ is hydrogen, C₁-C₄alkyl, C₃-C₅cycloalkyl or C₁-C₄alkoxy;
R¹² is aryl optionally substituted by one or more R¹⁵, arylalkyl optionally substituted by one or more R¹⁵, a 7- to 11-membered isocyclic ring system optionally substituted by one or more R¹⁶′, wherein the isocyclic ring system contains at least one aromatic cycle, heteroaryl optionally substituted by one or more R¹⁵, heteroarylalkyl optionally substituted by one or more R¹⁵, a 7- to 11-membered heterocyclic ring system optionally substituted by one or more R¹⁶, or group C-1

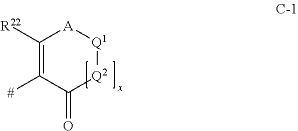

each R¹⁵ independently is halogen, cyano, amino, nitro, hydroxyl, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkykloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₄alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein aryl and heterocyclyl are optionally substituted by one or more R¹⁷;
each R¹⁶ independently is halogen, cyano, amino, nitro, hydroxyl, oxo, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₄alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein aryl and heterocyclyl are optionally substituted by one or more R¹⁷;
each R¹⁷ independently is halogen, cyano, C₁-C₄alkyl, C₁-C₄haloalkyl, C₁-C₄alkoxy or C₁-C₄haloalkoxy;

### A is C(R²⁵R²⁶), C(═O), C(═S), NR³¹, O or S;

### Q¹ is C(R²⁷R²⁸), C(═O), C(═S), NR³¹, O or S;

### Q² is C(R²⁹R³⁰), C(═O), C(═S), NR³¹, O or S;

R²² is hydroxyl, O⁻M⁺, OC(═O)R³⁵, amino or NHR³²;
x is 0 or 1, providing that when x is 1, Q¹ and Q² cannot both be oxygen;
M⁺ is a metal cation or ammonium cation;
R²⁵, R²⁶ R²⁷, R²⁸, R²⁹ and R³⁰ each independently are hydrogen, halogen, hydroxyl, amino, cyano, C₁-C₈alkyl, C₂-C₈alkenyl, C₂-C₈alkynyl, C₃-C₈cycloalkyl, C₁-C₈alkoxy, C₁-C₈alkylthio, C₁-C₈alkylsulfonyl, C₁-C₈alkylsulfinyl, aryl, heteroaryl or NHR²², wherein alkyl, alkenyl, alkynyl, cycloalkyl, aryl and heteroaryl are optionally substituted by one or more R³³; and wherein
R²⁵ and R²⁶, R²⁷ and R²⁸, and/or R²⁹ and R³⁰ may together form a saturated three- to six-membered alicyclic or heterocyclic ring wherein the aliyclic and heterocyclic rings are optionally substituted by one or more R³⁴; and/or
R²⁵ and R²⁷, and/or R²⁸ and R²⁹ may together form a saturated or partially unsaturated four- to seven-membered alicyclic or heterocyclic ring wherein the aliyclic and heterocyclic rings are optionally substituted by one or more R³⁴; and/or
R²⁵ and R²⁹ may together form a saturated or partially unsaturated four- to seven-membered alicyclic or heterocyclic ring wherein the aliyclic and heterocyclic rings are optionally substituted by one or more R³⁴;
R³¹ and R³² each independently are hydrogen, C₁-C₈alkyl, C₁-C₈haloalkyl C₂-C₈alkenyl, C₁-C₈haloalkenyl C₂-C₈alkynyl, C₂-C₈haloalkynyl, C₃-C₈cycloalkyl, C₃-C₈halocycloalkyl, C₁-C₈alkoxy, C₁-C₈haloalkoxy, C₁-C₈alkylcarbonyl, C₁-C₈haloalkylcarbonyl, C₁-C₈alkylsulfonyl, C₁-C₈haloalkylsulfonyl, amino, NH(C₁-C₈alkyl), N(C₁-C₈alkyl)₂, aryl or heterocyclyl, wherein aryl and heterocyclyl are optionally substituted by one or more R³⁴;
each R³³ independently is halogen, cyano, amino, nitro, hydroxyl, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, wherein alkyl, alkenyl, alkynyl and cycloalkyl are optionally substituted by halogen, and wherein aryl and heterocyclyl are optionally substituted by one or more R³⁴;
each R³⁴ independently is halogen, cyano, C₁-C₄alkyl, C₁-C₄haloalkyl, C₁-C₄alkoxy or C₁-C₄haloalkoxy; and
R³⁵ is C₁-C₆alkyl, C₁-C₆alkoxy or C₁-C₆alkylcarboxy; or a salt or a N-oxide thereof.

Where substituents are indicated as being optionally substituted, this means that they may or may not carry one or more identical or different substituents, e.g. one to five substituents, e.g. one to three substituents. Normally not more than three such optional substituents are present at the same time. Where a group is indicated as being substituted, e.g. alkyl, unless stated otherwise this includes those groups that are part of other groups, e.g. the alkyl in alkylthio, the alkyl in alkoxy, the aryl in aryloxy etc.

The term “halogen” refers to fluorine, chlorine, bromine or iodine, preferably fluorine, chlorine or bromine.

Alkyl substituents, alone or as part of a larger group, may be straight-chained or branched. Alkyl on its own or as part of another substituent is, depending upon the number of carbon atoms mentioned, for example, methyl, ethyl, n-propyl, n-butyl, n-pentyl, n-hexyl and the isomers thereof, for example, iso-propyl, iso-butyl, sec-butyl, tert-butyl, iso-amyl or pivaloyl.

Alkenyl substituents, alone or as part of a larger group, can be in the form of straight or branched chains, and the alkenyl moieties, where appropriate, can be of either the (E)- or (Z)-configuration. Examples are vinyl and allyl. The alkenyl groups are preferably C₂-C₆, more preferably C₂-C₄ and most preferably C₂-C₃ alkenyl groups.

Alkynyl substituents, alone or as part of a larger group, can be in the form of straight or branched chains. Examples are ethynyl and propargyl. The alkynyl groups are preferably C₂-C₆, more preferably C₂-C₄ and most preferably C₂-C₃ alkynyl groups.

Haloalkyl groups, alone or as part of a larger group, may contain one or more identical or different halogen atoms and, for example, may stand for CH₂Cl, CHCl₂, CCl₃, CH₂F, CHF₂, CF₃, CF₃CH₂, CH₃CF₂, CF₃CF₂ or CCl₃CCl₂.

Haloalkenyl groups, alone or as part of a larger group, are alkenyl groups, respectively, which are substituted with one or more of the same or different halogen atoms and are, for example, 2,2-difluorovinyl or 1,2-dichloro-2-fluoro-vinyl.

Haloalkynyl groups, alone or as part of a larger group, are alkynyl groups, respectively, which are substituted with one or more of the same or different halogen atoms and are, for example, 1-chloro-prop-2-ynyl.

Alkoxy, alone or as part of a larger group, refers to a radical —OR, where R is alkyl, e.g. as defined above. Alkoxy groups include, but are not limited to, methoxy, ethoxy, 1-methylethoxy, propoxy, butoxy, 1-methylpropoxy and 2-methylpropoxy.

Cyano refers to an CN group.

Amino means an NH₂ group.

Hydroxyl or hydroxy refers to an OH group.

Oxo refers to an ═O substituent. It will be clear that carbon atoms may be substituted by oxo only when two valency positions are available, e.g. phenyl cannot be substituted by oxo.

Aryl alone or part of a larger group, e.g. aryloxy, refers to a ring system which may be mono-, bi- or tricyclic. Examples of such rings include phenyl, naphthalenyl, anthracenyl, indenyl or phenanthrenyl. A preferred aryl group is phenyl.

Heteroaryl alone or as part of a larger group refers to an aromatic ring system, which may be a mono-, bi- or tricyclic systems wherein at least one oxygen, nitrogen or sulfur atom is present as a ring member Monocyclic and bicyclic aromatic ring systems are preferred, monocyclic ring systems are more preferred. For example, monocyclic heteroaryl may be a 5- to 7-membered, preferably 5- to 6-membered, aromatic ring containing one to three heteroatoms selected from oxygen, nitrogen and sulfur, more preferably selected from nitrogen and sulfur. Bicyclic heteroaryl may be a 9- to 11-membered bicyclic ring containing one to five heteroatoms, preferably one to three heteroatoms, independently selected from oxygen, nitrogen and sulfur. Examples are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, imiazothiazoyl, quinolinyl, quinoxalinyl, isoquinolinyl, phthalazinyl, quinoxalinyl, quinazolinyl, cinnolinyl and naphthyridinyl, preferably pyridyl, pyrazinyl, pyridazinyl, pyrimidinyl, pyrrolyl, pyrazolyl, imidazolyl, triazolyl, furanyl, thienyl, thiazolyl or thiadiazolyl. Heteroaryl rings do not contain adjacent oxygen ring atoms, adjacent sulfur ring atoms or adjacent oxygen and sulfur ring atoms. A link to a heteroaryl group can be via a carbon atom or via a nitrogen atom.

Isocyclic ring systems, alone or as part of a larger group, are saturated, partially unsaturated or fully unsaturated ring systems containing only carbon ring atoms, and may be a monocyclic, bicyclic or tricyclic system. Bi- and tricyclic ring systems may be annelated or spirocyclic. Isocyclic ring systems preferably contain 7- to 11 ring atoms and are bicyclic. An example is tetralinyl.

The terms heterocyclic ring system and heterocyclyl are used interchangeably and refer to, alone or as part of a larger group, saturated, partially unsaturated or fully unsaturated ring systems containing carbon ring atoms and one to four heteroatoms, preferably one to three heteroatoms, more preferably one or two heteroatoms, independently selected from nitrogen, oxygen and sulfur (without containing adjacent oxygen ring atoms, adjacent sulfur ring atoms or adjacent oxygen and sulfur ring atoms) as ring atoms, and may be a monocyclic, bicyclic or a tricyclic system. Bi- and tricyclic ring systems may be annelated or spirocyclic. Heterocyclic ring systems preferably contain 7- to 11 ring atoms and are bicyclic. Preferably bicyclic rings contain no more than three heteroatoms in each cycle, more preferably no more than 2 heteroatoms in each cycle.

Arylalkyl, alone or as part of a larger group, refers to the group A-D in which A is an aryl group as defined above, and D is an alkyl group as defined above. An example is phenyl-C₁-C₄alkyl, e.g. benzyl.

Heteroarylalkyl, alone or as part of a larger group, refers to the group B-D in which B is a heteroaryl group as defined above and D is an alkyl group as defined above. An example is heteroaryl-C₁-C₄alkyl, e.g. heteroaryl-CH₂—. Further examples are pyridyl-C₁-C₄alkyl and thienyl-C₁-C₄alkyl, e.g. pyridyl-CH₂ and thienyl-CH₂.

The presence of one or more possible asymmetric carbon atoms in a compound of formula I means that the compounds may occur in optically isomeric forms, i.e. enantiomeric or diastereomeric forms. Also atropisomers may occur as a result of restricted rotation about a single bond. Formula I is intended to include all those possible isomeric forms and mixtures thereof. The present invention includes all those possible isomeric forms and mixtures thereof for a compound of formula I. Likewise, formula I is intended to include all possible tautomers. The present invention includes all possible tautomeric forms for a compound of formula I.

In each case, the compounds of formula I according to the invention are in free form, in oxidized form as a N-oxide or in salt form, e.g. an agronomically usable salt form.

N-oxides are oxidized forms of tertiary amines or oxidized forms of nitrogen containing heteroaromatic compounds. They are described for instance in the book “Heterocyclic N-oxides” by A. Albini and S. Pietra, CRC Press, Boca Raton 1991.

The following list provides definitions, including preferred definitions, for substituents G¹, G², G³, T, Y¹, Y², n, p, R¹, R², R³, R⁴, R⁵, R⁶, R⁷, R⁸, R⁹, R¹⁰, R¹¹, R¹², R¹³, R¹⁴, R¹⁵, R¹⁶ and R¹⁷ with reference to compounds of formula I and other compounds of the invention carrying the same substituents. For any one of these substituents, any of the definitions given below may be combined with any definition of any other substituent given below or elsewhere in this document.

G¹, G² and G³ are independently O or S.

G¹ is preferably O.

G² is preferably S.

G³ is preferably 0.

T is CR¹³ or N, preferably CH or N, more preferably CH.

Y¹ and Y² are independently CR¹⁴ or N.

Y¹ is preferably CH or N, more preferably N.

Y² is preferably CH or N; more preferably CH.

n is 1 or 2, preferably 2.

p is 1 or 2, providing that when n is 2, p is 1, preferably p is 1.

x is 1 or 0, preferably 1.

A is C(R²⁵R²⁶), C(═O), C(═S), NR³¹, O or S; Q¹ is C(R²⁷R²⁸), C(═O), C(═S), NR³¹, O or S; Q² is C(R²⁹R³⁰), C(═O), C(═S), NR³¹, O or S. Preferably there are no —O—O—, —S—S—, —O—S— or —S—O— in the ring formed by A, Q¹ and Q². Preferably there are no adjacent C═O groups in the ring formed by A, Q¹ and Q². Preferably no more than two of A, Q¹ and Q² are NR³¹, O or S. In one group of compounds there are no adjacent heteroatoms in the ring formed by A, Q¹ and Q². In another group of compounds no more than one of A, Q¹ and Q² are NR³¹, O or S. In another group of compounds when x is 1 A is C(R²⁵R²⁶), NR²⁷, O or s; Q¹ is C(R²⁷R²⁸), C(═O), C(═S), NR²⁷, O or S; and Q² is C(R²⁹R³⁰), NR²⁷, O or S. In another group of compounds when x is 0, A is C(R²⁵R²⁶), C(═O), C(═S), NR²⁷, O or S; Q¹ is C(R²⁷R²⁸), NR²⁷, O or S. Even more preferred options for A, Q¹ and Q² are depicted by Z1 to Z19 (see below).

R¹, R², R³, R⁴, R⁵, R⁶, R⁷, R⁸, R⁹, R¹⁰, R¹³ and R¹⁴ each independently are hydrogen, halogen, cyano, C₁-C₄alkyl or C₁-C₄haloalkyl, preferably hydrogen, halogen, C₁-C₄alkyl or C₁-C₄haloalkyl.

Preferably R¹ and R² are each independently halogen, methyl or halomethyl, more preferably methyl or halomethyl, more preferably methyl or trifluoromethyl. Preferably R¹ is trifluoromethyl. Preferably R² is methyl. In one group of compounds R¹ is trifluoromethyl and R² is methyl. In another group of compounds R¹ and R² are both difluoromethyl.

Preferably R³, R⁴, R⁵, R⁶, R⁷, R⁸, R⁹, R¹⁰, R¹³ and R¹⁴ are each independently hydrogen, halogen, C₁-C₄alkyl or C₁-C₄haloalkyl, more preferably hydrogen, halogen, methyl or halomethyl, even more preferably hydrogen or methyl, most preferably hydrogen.

R¹¹ is hydrogen, C₁-C₄alkyl, C₃-C₅cycloalkyl or C₁-C₄alkoxy; preferably hydrogen, C₁-C₄alkyl or C₁-C₄alkoxy, more preferably hydrogen or methyl, even more preferably hydrogen.

R¹² is aryl optionally substituted by one or more R¹⁵, arylalkyl optionally substituted by one or more R¹⁵, a 7- to 11-membered isocyclic ring system optionally substituted by one or more R¹⁶′, wherein the isocyclic ring system contains at least one aromatic cycle, heteroaryl optionally substituted by one or more R¹⁵, heteroarylalkyl optionally substituted by one or more R¹⁵, a 7- to 11-membered heterocyclic ring system optionally substituted by one or more R¹⁶, wherein the heterocyclic ring system contains at least one aromatic cycle, or group C-1.

Preferably, R¹² is phenyl optionally substituted by one or more R¹⁵, phenyl-C₁-C₄alkyl optionally substituted by one or more R¹⁵, a 7- to 11-membered isocyclic bicyclic ring system optionally substituted by one or more R¹⁶, wherein the isocyclic bicyclic ring system contains an aromatic cycle and a non-aromatic cycle, 5-6 membered heteroaryl optionally substituted by one or more R¹⁵, 5-6 membered heteroaryl-C₁-C₄alkyl optionally substituted by one or more R¹⁵, or a 7- to 11-membered heterocyclic ring system, optionally substituted by one or more R¹⁶, containing an aromatic cycle and a non-aromatic cycle, or group C-1.

Preferably the heteroaryl of R¹² (and heteroaryl as part of heteroarylalkyl) is selected from the specific 5-6 membered groups indicated above under the definition of heteroaryl, in particular pyridyl, pyrazinyl, pyridazinyl, pyrimidinyl, pyrrolyl, pyrazolyl, imidazolyl, triazolyl, furanyl, thienyl, thiazolyl and thiadiazolyl.

Preferably the 7- to 11-membered isocyclic bicyclic ring system of R¹² contains an aromatic cycle and a non-aromatic cycle, and more preferably is selected from the following each optionally substituted by one or more R¹⁶ (9- to 10-membered rings are preferred)

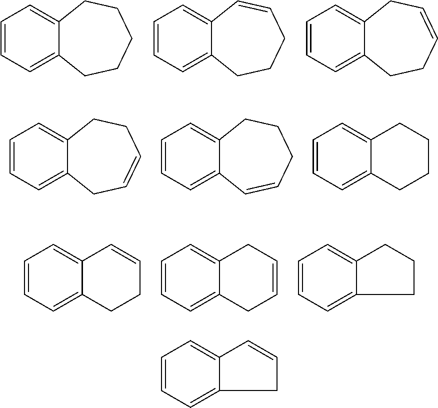

in particular groups A-1 to A-15, each optionally substituted by one or more R¹⁶ ((9- to 10-membered rings are preferred)

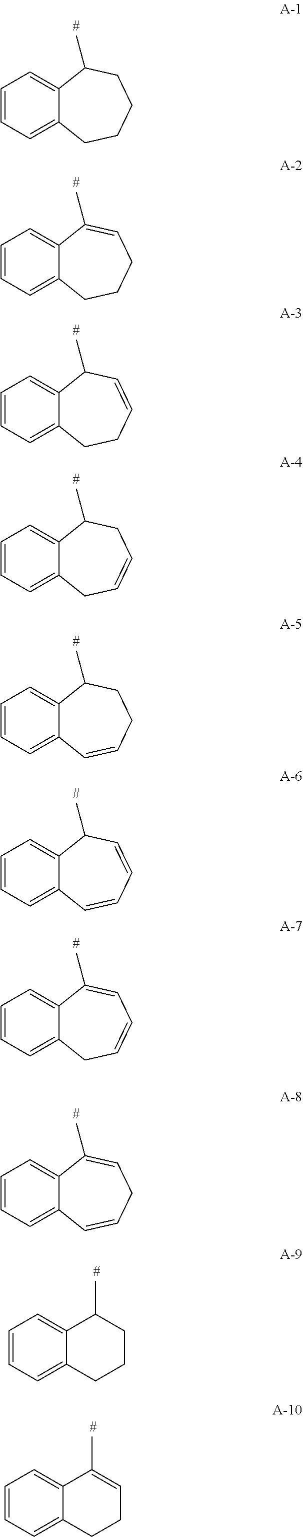

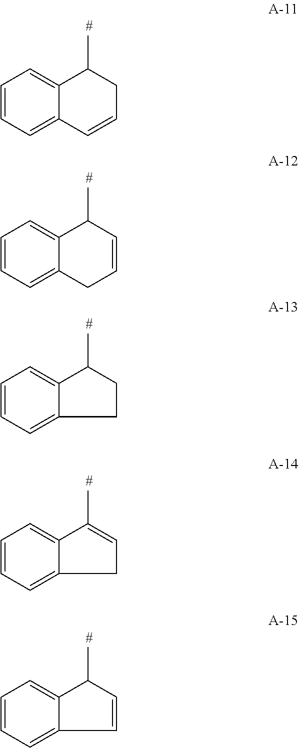

A-9 to A-15 are more preferred, A-9 and A-13 are even more preferred, A-9 is most preferred, each optionally substituted by one or more R¹⁶.

Preferably the 7- to 11-membered heterocyclic bicyclic ring system of R¹² contains an aromatic cycle and a non-aromatic cyclic, and more preferably is selected from the following, each optionally substituted by one or more R¹⁶ (9- to 10-membered rings are preferred)

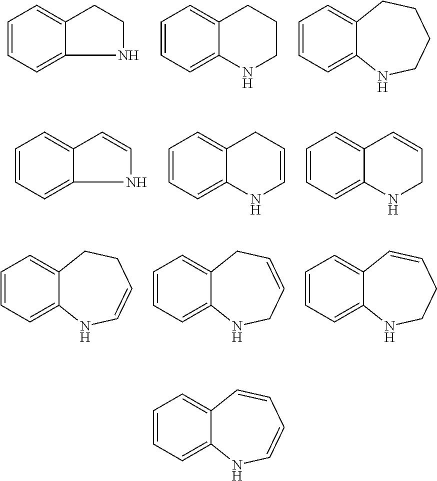

in particular groups B-1 to B-10 each optionally substituted by one or more R¹⁶ (9- to 10-membered rings are preferred)

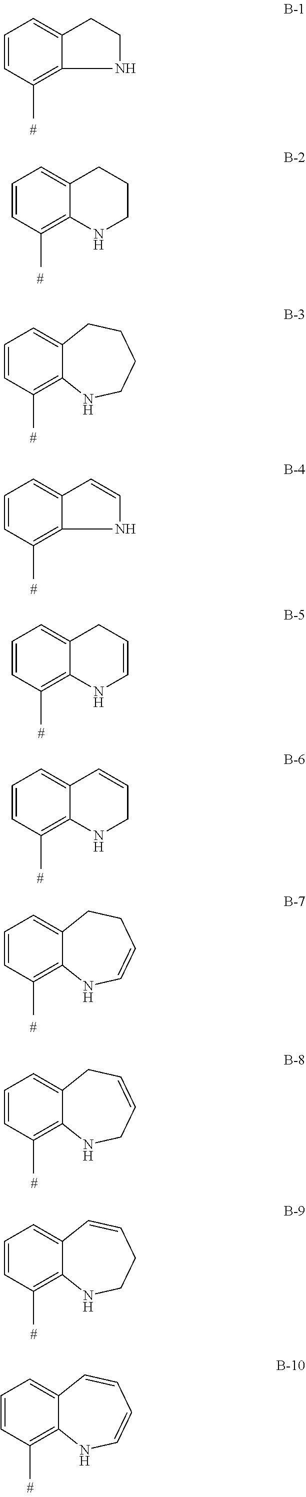

each optionally substituted by one or more R¹⁶, and is even more preferably selected from B-1a and B-2a

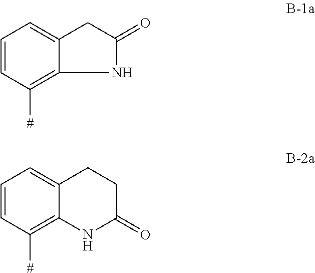

each optionally substituted by one or more R¹⁶.

In one group of compounds R¹² is aryl optionally substituted by one or more R¹⁵, arylalkyl optionally substituted by one or more R¹⁵, a 7- to 11-membered isocyclic ring system optionally substituted by one or more R¹⁶′, wherein the isocyclic ring system contains at least one aromatic cycle, with preferred definitions thereof as indicated above.

In one group of compounds R¹² is heteroaryl optionally substituted by one or more R¹⁵, heteroarylalkyl optionally substituted by one or more R¹⁵, a 7- to 11-membered heterocyclic ring system optionally substituted by one or more R¹⁶, wherein the heterocyclic ring system contains at least one aromatic cycle, with preferred definitions thereof as indicated above.

In one group of compounds R¹² is group C-1.

In one group of compounds R¹² is arylalkyl, a 6- to 10-membered isocyclic ring system or a 5- to 10-membered heterocyclic ring system, wherein the arylalkyl is optionally substituted by one or more R¹⁵ and the 6- to 10-membered isocyclic ring system and the 5- to 10-membered heterocyclic ring system are optionally substituted by one or more R¹⁶; more preferably benzyl, phenyl, thiophene or pyridine, wherein the benzyl is optionally substituted by one or more R¹⁵ and the phenyl, thienyl and pyridyl are optionally substituted by one or more R¹⁶. In one group of compounds R¹² is phenyl substituted

In one group of compounds R¹² is phenyl substituted by hydroxyl or C₁-C₄alkylcarboxy, and optionally substituted by one or two further substituents as defined above. Preferably the hydroxyl or C₁-C₄alkylcarboxy is at the ortho position. Preferably one of the further substituents is halogen and is preferably at the meta position adjacent to the hydroxyl or C₁-C₄alkylcarboxy.

In one group of compounds R¹² is phenyl substituted C₁-C₄alkylcarboxy, and optionally substituted by one or two further substituents as defined above. Preferably the C₁-C₄alkylcarboxy is at the ortho position. Preferably one of the further substituents is halogen and is preferably at the meta position adjacent to the C₁-C₄alkylcarboxy.

In one group of compounds R¹² is heteroaryl (e.g. pyridyl or thienyl) substituted by hydroxyl or C₁-C₄alkylcarboxy, and optionally substituted by one or two further substituents as defined above. Preferably the hydroxyl or C₁-C₄alkylcarboxy is at the ortho position with respect to the ring atom containing the R¹² bond. Preferably one of the further substituents is halogen and is preferably at the ring position adjacent to the hydroxyl or C₁-C₄alkylcarboxy. Preferably the heteroatom is located at the ortho position with respect to the ring atom containing the R¹² bond

In one group of compounds R¹² is heteroaryl (e.g. pyridyl or thienyl) substituted by C₁-C₄alkylcarboxy, and optionally substituted by one or two further substituents as defined above. Preferably the C₁-C₄alkylcarboxy is at the ortho position with respect to the ring atom containing the R¹² bond. Preferably one of the further substituents is halogen and is preferably at the ring position adjacent to the C₁-C₄alkylcarboxy. Preferably the heteroatom is located at the ortho position with respect to the ring atom containing the R¹² bond

Each R¹⁵ is independently, halogen, cyano, amino, nitro, hydroxyl, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₄alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein the aryl and heterocyclyl are optionally substituted by one or more R¹⁷.

Preferably each R¹⁵ independently is halogen, cyano, amino, nitro, hydroxyl, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, phenyl, phenyloxy, phenylthio, phenylsulfonyl, phenylsulfinyl, phenyl-C₁-C₄alkyl, phenyl-C₁-C₄alkyloxy, phenyl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₈alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein aryl and heterocyclyl are optionally substituted by one or more R¹⁷; and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholinyl and tetrahydropyranyl.

More preferably each R¹⁵ independently is halogen, cyano, amino, mercapto, hydroxyl, nitro, C₁-C₈alkyl, C₃-C₈cycloalkyl, C₃-C₈cycloalkyl-C₁-C₄alkyloxy, C₃-C₈cycloalkyl-C₁-C₄alkylthio, C₁-C₈alkoxy, C₁-C₈alkylthio, phenyl, phenyloxy, phenylthio, phenyl-C₁-C₄alkoxy, phenyl-C₁-C₄alkylthio, heterocyclyl, heterocyclyl-C₁-C₄alkoxy, heterocyclyl-C₁-C₄alkylthio, NH(C₁-C₈alkyl), N(C₁-C₈alkyl)₂, C₁-C₄alkylcarboxy, and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholinyl and tetrahydroyranyl, and wherein alkyl and cycloalkyl are optionally substituted by halogen, and wherein aryl and heterocyclyl moieties are optionally substituted by one or more R¹⁷.

Even more preferably each R¹⁵ independently is halogen, cyano, amino, mercapto, hydroxyl, nitro, C₁-C₄alkyl, C₃-C₆cycloalkyl, C₃-C₆cycloalkyl-C₁-C₄alkylthio, C₁-C₄alkoxy, C₁-C₄alkylthio, C₁-C₄alkylcarboxy, phenyl or phenyloxy, and wherein alkyl and cycloalkyl are optionally substituted by halogen, and wherein phenyl is optionally substituted by one or more R¹⁷. Even more preferably each R¹⁵ independently is halogen, cyano, hydroxyl, nitro, C₁-C₄alkyl, C₁-C₄haloalkyl, C₁-C₄alkoxy, C₁-C₄haloalkoxy, or C₁-C₄alkylcarboxy, most preferably fluoro, chloro, bromo, cyano, hydroxyl, nitro, methyl, halomethyl, methoxy, halomethoxy, hydroxyl or methylcarboxy.

Each R¹⁶ is independently, halogen, cyano, amino, nitro, hydroxyl, oxo, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₈alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein the aryl and heterocyclyl are optionally substituted by one or more R¹⁷.

Preferably each R¹⁶ independently is halogen, cyano, amino, nitro, hydroxyl, oxo, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, phenyl, phenyloxy, phenylthio, phenylsulfonyl, phenylsulfinyl, phenyl-C₁-C₄alkyl, phenyl-C₁-C₄alkyloxy, phenyl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₈alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein aryl and heterocyclyl are optionally substituted by one or more R¹⁷; and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholinyl and tetrahydropyranyl.

More preferably each R¹⁶ independently is halogen, cyano, amino, hydroxyl, keto, mercapto, C₁-C₈alkyl, C₃-C₈cycloalkyl, C₃-C₈cycloalkyl-C₁-C₄alkyloxy, C₃-C₈cycloalkyl-C₁-C₄alkylthio, C₁-C₈alkoxy, C₁-C₈alkylthio, phenyl, phenyloxy, phenylthio, phenyl-C₁-C₄alkoxy, phenyl-C₁-C₄alkylthio, heterocyclyl, heterocyclyl-C₁-C₄alkoxy, heterocyclyl-C₁-C₄alkylthio, NH(C₁-C₈alkyl), N(C₁-C₈alkyl)₂, C₁-C₄alkylcarboxy, and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholinyl, and tetrahydroyranyl, and wherein alkyl and cycloalkyl are optionally substituted by halogen, and wherein aryl and heterocyclyl moieties are optionally substituted by one or more R¹⁷.

Even more preferably each R¹⁶ independently is halogen, cyano, amino, hydroxyl, keto, mercapto, C₁-C₄alkyl, C₃-C₈cycloalkyl, C₃-C₈cycloalkyl-C₁-C₄alkylthio, C₁-C₄alkoxy, C₁-C₄alkylthio, C₁-C₄alkylcarboxy phenyl or phenyloxy, and wherein alkyl and cycloalkyl are optionally substituted by halogen, and wherein phenyl is optionally substituted by one or more R¹⁷. Even more preferably each R¹⁶ independently is halogen, cyano, hydroxyl, nitro, C₁-C₄alkyl, C₁-C₄haloalkyl, C₁-C₄alkoxy, C₁-C₄haloalkoxy, or C₁-C₄alkylcarboxy, most preferably fluoro, chloro, bromo, cyano, hydroxyl, nitro, methyl, halomethyl, methoxy, halomethoxy, hydroxyl or methylcarboxy.

Each R¹⁷ is independently halogen, cyano, C₁-C₄alkyl, C₁-C₄haloalkyl, C₁-C₄alkoxy or C₁-C₄haloalkoxy, preferably halogen, cyano, methyl, halomethyl, methoxy or halomethoxy, more preferably halogen, methyl or halomethyl.

Group C-1 may occur in different tautomeric forms, for example, if R²² is hydroxyl, in the formulas C-1a, C-1b and C-1c. Each form is included within the definition of group C-1.

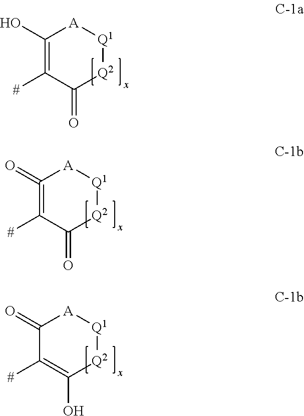

R²² is hydroxyl, O⁻M⁺, OC(═O)R³⁵, amino or NHR³²; preferably hydroxyl, O⁻M⁺, or NHR³², more preferably hydroxyl or O⁻M⁺, even more preferably hydroxyl.

M⁺ is a metal cation or ammonium cation, preferably a metal cation, e.g. an alkali metal cation, such as potassium, sodium or lithium.

R²⁵, R²⁶, R²⁷, R²⁸, R²⁹ and R³⁰ each independently are hydrogen, halogen, hydroxyl, amino, cyano, C₁-C₈alkyl, C₂-C₈alkenyl, C₂-C₈alkynyl, C₃-C₈cycloalkyl, C₁-C₈alkoxy, C₁-C₈alkylthio, C₁-C₈alkylsulfonyl, C₁-C₈alkylsulfinyl, aryl, heteroaryl or NHR²², wherein alkyl, alkenyl, alkynyl, cycloalkyl, aryl and heteroaryl are optionally substituted by one or more R²³.

Preferably R²⁵, R²⁶ R²⁷, R²⁸, R²⁹ and R³⁰ each independently are hydrogen, halogen, hydroxyl, cyano, C₁-C₈alkyl, C₂-C₈alkenyl, C₂-C₈alkynyl, C₃-C₈cycloalkyl, C₁-C₈alkoxy, C₁-C₈alkylthio, aryl, heteroaryl or NHR³², wherein alkyl, alkenyl, alkynyl, cycloalkyl, aryl and heteroaryl are optionally substituted by one or more R³³.

Preferably R²⁵, R²⁶ R²⁷, R²⁸, R²⁹ and R³⁰ each independently are hydrogen, halogen, hydroxyl, cyano, C₁-C₈alkyl, C₂-C₈alkenyl, C₂-C₈alkynyl, C₃-C₈cycloalkyl, C₁-C₈alkoxy, C₁-C₈alkylthio, aryl, heteroaryl or NHR³², wherein alkyl, alkenyl, alkynyl, cycloalkyl, aryl and heteroaryl are optionally substituted by one or more R³³ and wherein each heteroaryl is independently selected from pyridyl, pyrazinyl, pyridazinyl, pyrimidinyl, pyrrolyl, pyrazolyl, imidazolyl, triazolyl, furanyl, thienyl thiazolyl and thiadiazolyl.

Even more preferably R²⁵, R²⁶ R²⁷, R²⁸, R²⁹ and R³⁰ each independently are hydrogen, halogen, cyano, C₁-C₄alkyl, C₃-C₆cycloalkyl-C₁-C₄alkyl, C₃-C₆cycloalkyl-C₁-C₄alkyl wherein one ring atom is replaced by oxygen, C₂-C₄alkenyl, C₂-C₄alkynyl, C₃-C₆cycloalkyl, C₁-C₄alkylthio-C₃-C₆cycloalkyl, phenylthio-C₃-C₆cycloalkyl, benzylthio-C₃-C₆cycloalkyl, C₃-C₆cycloalkyl wherein one ring atom is replaced by oxygen, C₁-C₄alkoxy, C₁-C₄alkylthio, C₁-C₄alkylcarbonylamino, wherein alkyl, alkenyl, alkynyl, and cycloalkyl are optionally substituted by one to five halogen, and wherein phenyl and benzyl are optionally substituted by one to five groups selected from halogen, cyano, C₁-C₄alkyl, C₁-C₄haloalkyl, C₁-C₄alkoxy and C₁-C₄haloalkoxy.

R²⁵ and R²⁶, R²⁷ and R²⁸, and/or R²⁹ and R³⁰ may together form a saturated three- to six-membered alicyclic or heterocyclic ring wherein the aliyclic and heterocyclic rings are optionally substituted by one or more R³⁴; and/or

R²⁵ and R²⁷, and/or R²⁸ and R²⁹ may together form a saturated or partially unsaturated four- to seven-membered alicyclic or heterocyclic ring wherein the aliyclic and heterocyclic rings are optionally substituted by one or more R³⁴; and/or

R²⁵ and R²⁹ may together form a saturated or partially unsaturated four- to seven-membered alicyclic or heterocyclic ring wherein the aliyclic and heterocyclic rings are optionally substituted by one or more R³⁴.

A heterocyclic ring formed by any of R²⁵ and R²⁶, R²⁷ and R²⁸, R²⁹ and R³⁰, R²⁵ and R²⁷, R²⁸ and R²⁹, and R²⁵ and R²⁹ contains for example one to three heteroatoms selected from O, S, and N(R³⁴).

Preferably R²⁵ and R²⁶, R²⁷ and R²⁸, and/or R²⁹ and R³⁰ may together form a saturated three- to six-membered alicyclic or heterocyclic ring wherein the aliyclic and heterocyclic rings are optionally substituted by one or more R³⁴; and/or

R²⁵ and R²⁷ may together form a saturated or partially unsaturated four- to seven-membered alicyclic or heterocyclic ring wherein the aliyclic and heterocyclic rings are optionally substituted by one or more R³⁴; and/or

R²⁵ and R²⁹ may together form a saturated or partially unsaturated four- to seven-membered alicyclic or heterocyclic ring wherein the aliyclic and heterocyclic rings are optionally substituted by one or more R³⁴; and where said heterocyclic rings preferably contain one or two heteroatoms selected from O, S and NR³⁴.

More preferably one or two of the pairs R²⁵ and R²⁶, R²⁷ and R²⁸, and R²⁹ and R³⁰ may together form a saturated three- to six-membered alicyclic or heterocyclic ring wherein the aliyclic and heterocyclic rings are optionally substituted by one or more R³⁴; or

R²⁵ and R²⁷ may together form a saturated or partially unsaturated four- to seven-membered alicyclic or heterocyclic ring wherein the aliyclic and heterocyclic rings are optionally substituted by one or more R³⁴; or

R²⁵ and R²⁹ may together form a saturated or partially unsaturated four- to seven-membered alicyclic or heterocyclic ring wherein the aliyclic and heterocyclic rings are optionally substituted by one or more R³⁴; and where said heterocyclic rings preferably contain one heteroatom selected from O, S and NR³⁴.

Even more preferably one or two of the pairs R²⁵ and R²⁶, R²⁷ and R²⁸, and R²⁹ and R³⁰ may together form a saturated three- to six-membered alicyclic ring wherein one of the ring members is optionally replaced by O, S, NH(C₁-C₄alkyl), NH(C₁-C₄alkoxy), and wherein the alicyclic ring is optionally substituted by one to five groups selected from halogen, methyl and halomethyl; or

R²⁵ and R²⁷ may together form a saturated four- to seven-membered alicyclic ring optionally substituted by one to five groups independently selected from halogen, methyl and halomethyl; or

R²⁵ and R²⁹ may together form a saturated four- to seven-membered alicyclic ring optionally substituted by one to five groups independently selected from halogen, methyl and halomethyl.

Each R³¹ and R³² independently are hydrogen, C₁-C₈alkyl, C₁-C₈haloalkyl C₂-C₈alkenyl, C₂-C₈haloalkenyl, C₂-C₈alkynyl, C₂-C₈haloalkynyl, C₃-C₈cycloalkyl, C₃-C₈halocycloalkyl, C₁-C₈alkoxy, C₁-C₈haloalkoxy, C₁-C₈alkylcarbonyl, C₁-C₈haloalkylcarbonyl, C₁-C₈alkylsulfonyl or C₁-C₈haloalkylsulfonyl, amino, NH(C₁-C₈alkyl), N(C₁-C₈alkyl)₂, aryl or heterocyclyl, wherein aryl and heterocyclyl are optionally substituted by one or more R³⁴.

Preferably each R³¹ and R³² independently are hydrogen, C₁-C₈alkyl, C₁-C₈haloalkyl, C₂-C₈alkenyl, C₂-C₈haloalkenyl, C₂-C₈alkynyl, C₂-C₈haloalkynyl, C₃-C₈cycloalkyl, C₃-C₈halocycloalkyl, C₁-C₈alkoxy, C₁-C₈haloalkoxy, C₁-C₈alkylcarbonyl, C₁-C₈haloalkylcarbonyl, C₁-C₈alkylsulfonyl or C₁-C₈haloalkylsulfonyl, amino, NH(C₁-C₈alkyl), N(C₁-C₈alkyl)₂, phenyl or heterocyclyl, wherein phenyl and heterocyclyl are optionally substituted by one or more R³⁴ and wherein each heterocycle is independently selected from pyrrolidinyl, pyrrolyl, imidazolyl, triazolyl, piperazinyl, piperidinyl, morpholinyl, pyridyl, pyrazinyl, pyridazinyl and pyrimidinyl.

More preferably each R³¹ and R³² independently are hydrogen, C₁-C₈alkyl, C₂-C₈alkenyl, C₂-C₈alkynyl, C₃-C₈cycloalkyl, C₁-C₈alkoxy, C₁-C₈alkylcarbonyl, NH(C₁-C₈alkyl), N(C₁-C₈alkyl)₂, phenyl, or a group selected from D1-D4

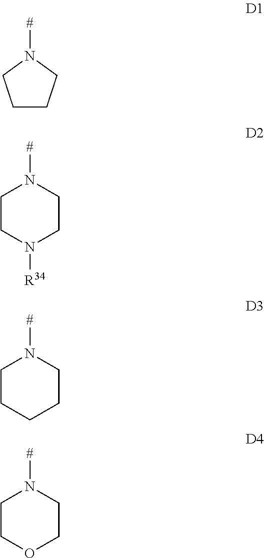

wherein the phenyl and D1-D4 are optionally substituted by one or more R³⁴.

Even more preferably each R³¹ and R³² independently are hydrogen, C₁-C₄alkyl, C₃-C₆cycloalkyl, C₁-C₄alkoxy, NH(C₁-C₄alkyl), N(C₁-C₄alkyl)₂, phenyl, D1 or D3, wherein phenyl and groups D1 and D3 are optionally substituted by one to five groups independently selected from halogen, methyl and halomethyl.

Each R³³ is independently, halogen, cyano, amino, nitro, hydroxyl, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, wherein alkyl, alkenyl, alkynyl and cycloalkyl are optionally substituted by halogen, and wherein the aryl and heterocyclyl are optionally substituted by one or more R³⁴.

Preferably each R³³ independently is halogen, cyano, amino, nitro, hydroxyl, mercapto, C₁-C₈ alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkylthio, C₁-C₈alkoxy, C₃-C₈cycloalkyloxy, C₂-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, phenyl, phenyloxy, phenylthio, phenylsulfonyl, phenylsulfinyl, phenyl-C₁-C₄alkyl, phenyl-C₁-C₄alkyloxy, phenyl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, wherein alkyl, alkenyl, alkynyl and cycloalkyl are optionally substituted by halogen, and wherein aryl and heterocyclyl are optionally substituted by one or more R³⁴; and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholinyl and tetrahydropyranyl.

More preferably each R³³ independently is halogen, cyano, amino, mercapto, C₁-C₈alkyl, C₃-C₈cycloalkyl, C₃-C₈cycloalkyl-C₁-C₄alkyloxy, C₃-C₈cycloalkyl-C₁-C₄alkylthio, C₁-C₈alkoxy, C₁-C₈alkylthio, phenyl, phenyloxy, phenylthio, phenyl-C₁-C₄alkoxy, phenyl-C₁-C₄alkylthio, heterocyclyl, heterocyclyl-C₁-C₄alkoxy, heterocyclyl-C₁-C₄alkylthio, NH(C₁-C₈alkyl), N(C₁-C₈alkyl)₂, and wherein heterocyclyl is independently selected from pyridyl, pyrazinyl, pyridazinyl, pyrimidinyl, pyrrolyl, pyrazolyl, imidazolyl, triazolyl, furanyl, thienyl, thiazolyl, thiadiazolyl, pyrrolidinyl, piperazinyl, piperidinyl, morpholiny, and tetrahydroyranyl, and wherein alkyl and cycloalkyl are optionally substituted by halogen, and wherein aryl and heterocyclyl moieties are optionally substituted by one or more R³⁴.

Even more preferably each R³³ independently is halogen, cyano, amino, mercapto, C₁-C₄alkyl, C₃-C₆cycloalkyl, C₃-C₆cycloalkyl-C₁-C₄alkylthio, C₁-C₄alkoxy, C₁-C₄alkylthio, phenyl and phenyloxy, and wherein alkyl and cycloalkyl are optionally substituted by halogen, and wherein phenyl is optionally substituted by one or more R³⁴.

Each R³⁴ is independently halogen, cyano, C₁-C₄alkyl, C₁-C₄haloalkyl, C₁-C₄alkoxy or C₁-C₄haloalkoxy, preferably halogen, cyano, methyl, halomethyl, methoxy or halomethoxy, more preferably halogen, methyl or halomethyl.

Preferably R³⁵ is C₁-C₄alkyl or C₁-C₄alkylcarboxy.

In particular group C-1 may be

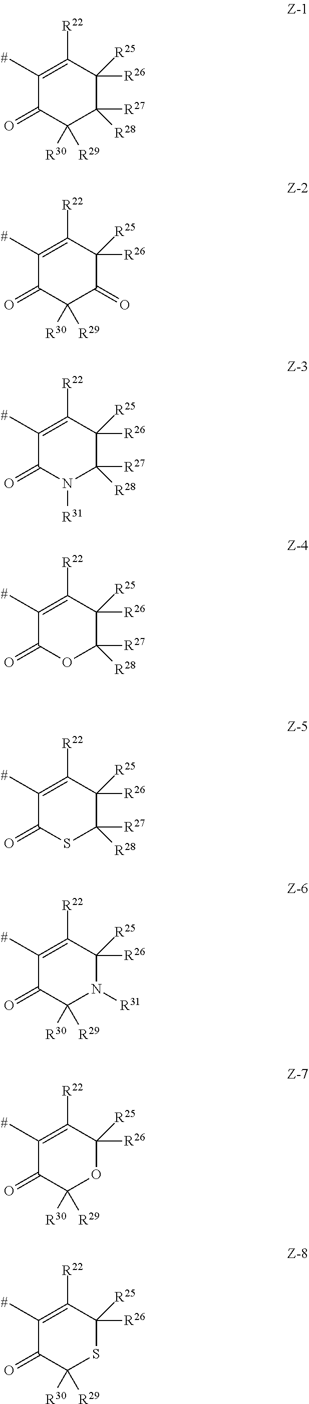

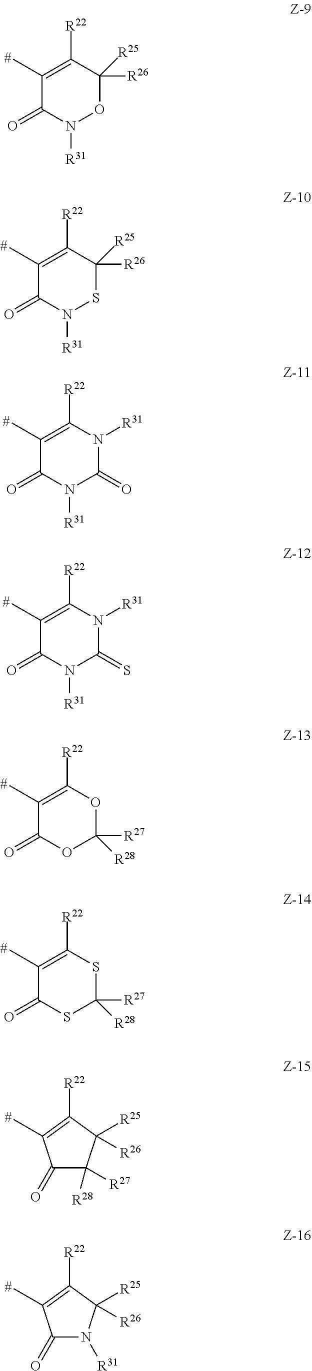

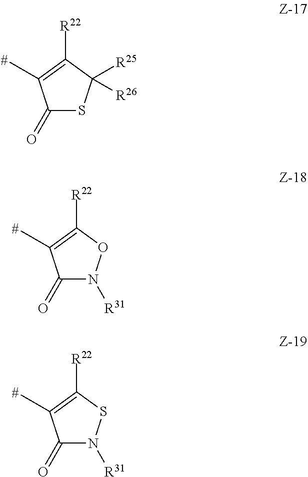

R²⁵, R²⁶, R²⁷, R²⁸, R²⁹ and R³⁰ may form alicyclic and/or heterocyclic rings as described above. Examples of Z in such cases include, but are not limited to, the following

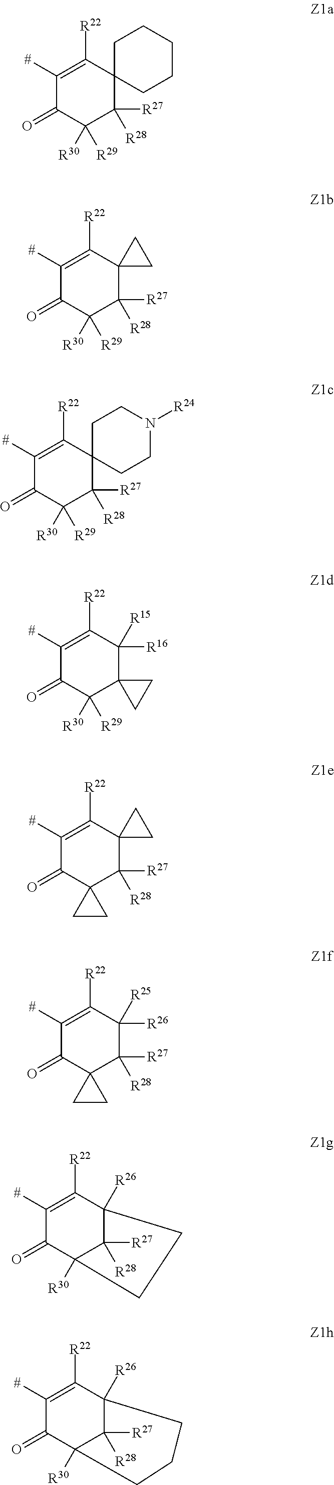

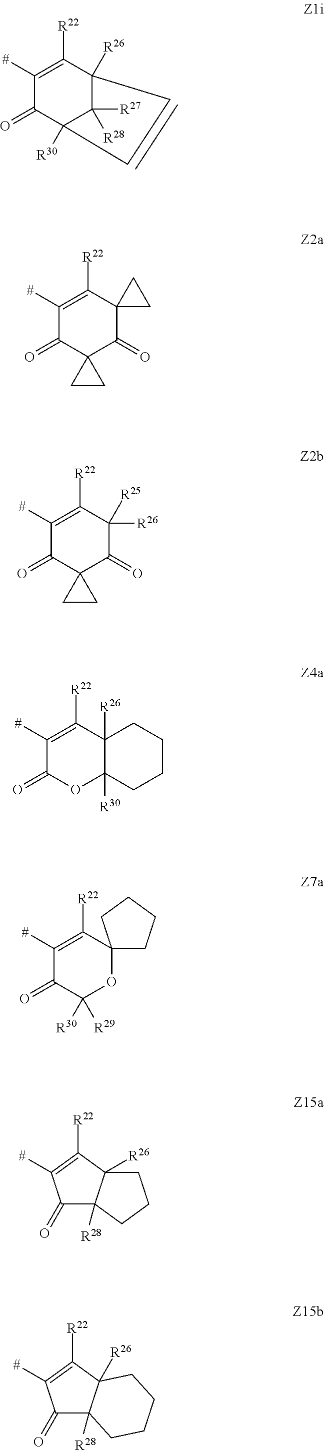

For the avoidance of doubt, when n is 1 and p is 1 compounds of formula I have the formula according to formula I-A:

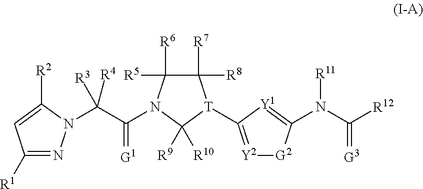

in which R¹, R², R³, R⁴, R⁵, R⁶, R⁷, R⁸, R⁹, R¹⁰, R¹¹, R¹², G¹, G², G³, T, Y¹ and Y² have the definitions as described for formula I.

When n is 2 and p is 1, compounds of formula I have the formula according to formula I-B:

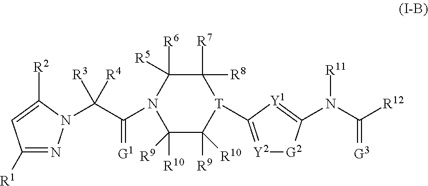

which R¹, R², R³, R⁴, R⁵, R⁶, R⁷, R⁸, R⁹, R¹⁰, R¹¹, R¹², G¹, G², G³, T, Y¹ and Y² have the definitions as described for formula I.

When n is 1 and p is 2, compounds of formula I have the formula according to formula I-C:

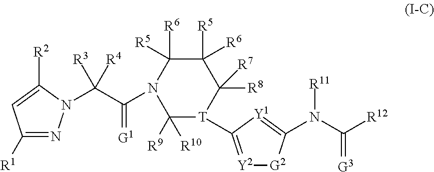

in which R¹, R², R³, R⁴, R⁵, R⁶, R⁷, R⁸, R⁹, R¹⁰, R¹¹, R¹², G¹, G², G³, T, Y¹ and Y² have the definitions as described for formula I.

The invention also relates to compounds of formula I-A, formula I-B and formula I-C as shown above.

The invention also relates to compounds of formula I-D:

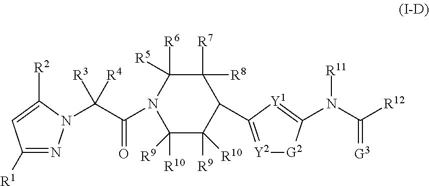

in which R¹, R², R³, R⁴, R⁵, R⁶, R⁷, R⁸, R⁹, R¹⁰, R¹¹, R¹², G², G³, Y¹ and Y² have the definitions as described for formula I. Preferred definitions of R¹, R², R³, R⁴, R⁵, R⁶, R⁷, R⁸, R⁹, R¹⁰, R¹¹, R¹², G², G³, Y¹ and Y² are as defined for formula I.

The invention also relates to compounds of formula I-E:

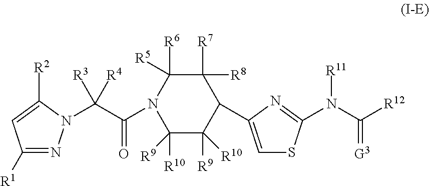

in which R¹, R², R³, R⁴, R⁵, R⁶, R⁷, R⁸, R⁹, R¹⁰, R¹¹, R¹² and G³ have the definitions as described for formula I. Preferred definitions of R¹, R², R³, R⁴, R⁵, R⁶, R⁷, R⁸, R⁹, R¹⁰, R¹¹, R¹² and G³ are as defined for formula I.

The invention also relates to compounds of formula I-F:

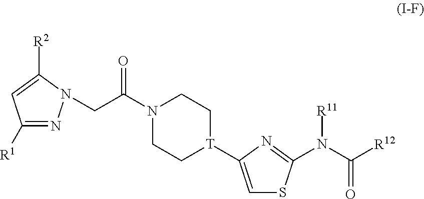

wherein T is CH or N, preferably CH; R¹¹ is CH₃ or H; and R¹, R² and R¹² have the definitions as described for formula I. Preferred definitions of R¹, R² and R¹² are as defined for formula I.

The invention also relates to compounds of formula I-G:

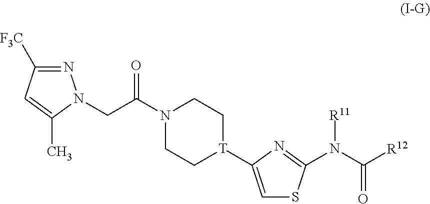

wherein T is CH or N, preferably CH; R¹¹ is CH₃ or H; and R¹² has the definition as described for formula I. Preferred definitions of R¹² are as defined for formula I.

The invention also relates to compounds of formula I-H:

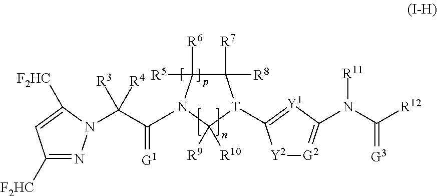

in which R³, R⁴, R⁵, R⁶, R⁷, R⁸, R⁹, R¹⁰, R¹¹, R¹², G¹, G², G³, Y¹, Y², n and p have the definitions as described for formula I. Preferred definitions of R¹, R², R³, R⁴, R⁵, R⁶, R⁷, R⁸, R⁹, R¹⁰, R¹¹, R¹², G¹, G², G³, Y¹, Y², n and p are as defined for formula I.

The invention also relates to compounds of formula kJ:

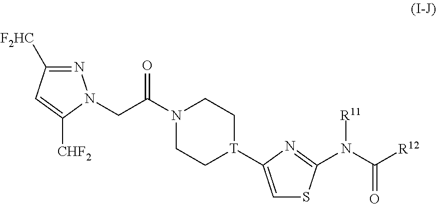

wherein T is CH or N, preferably CH; R¹¹ is CH₃ or H; and R¹² has the definition as described for formula I. Preferred definitions of R¹² are as defined for formula I.

The invention includes compounds of formula II:

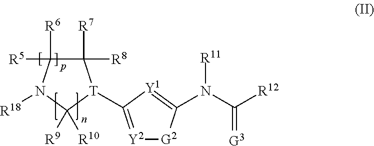

wherein R¹⁸ is hydrogen, a protecting group, such as alkylcarbonyl, benzyl or alkoxycarbonyl, e.g. 1-C₄ alkylcarbonyl, benzyl or 1-C₄ alkoxycarbonyl, in particular acetyl, benzyl or tert-butoxycarbonyl, and G², G³, T, Y¹, Y², n, p, R⁵, R⁶, R⁷, R⁸, R⁹, R¹⁰, R¹¹ and R¹² are as defined for a compound of formula I. These compounds, including salts and N-oxides thereof, are useful as intermediates in the synthesis of compounds of formula I. Preferred definitions of G², G³, T, Y¹, Y², n, p, R⁵, R⁶, R⁷, R⁸, R⁹, R¹⁰, R¹¹ and R¹² are as defined for formula I.

The invention also includes compounds of formula III

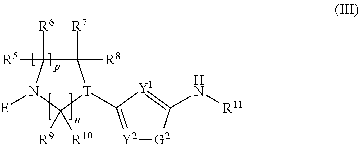

wherein E is hydrogen, a protecting group such as alkylcarbonyl, benzyl or alkoxycarbonyl, e.g. 1-C₄ alkylcarbonyl, benzyl or 1-C₄ alkoxycarbonyl, in particular acetyl, benzyl or tert-butoxycarbonyl; or group M

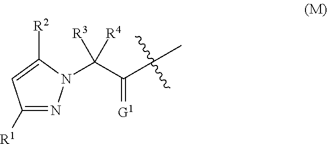

and G¹, G², T, Y¹, Y², n, p, R¹, R², R³, R⁴, R⁵, R⁶, R⁷, R⁸, R⁹, R¹⁰ and R¹¹ are as defined for a compound of formula I. These compounds, including salts and N-oxides thereof, are useful as intermediates in the synthesis of compounds of formula I. Preferred definitions of G¹, G², T, Y¹, Y², n, p, R¹, R², R³, R⁴, R⁵, R⁶, R⁷, R⁸, R⁹, R¹⁰ and R¹¹ are as defined for formula I.

The invention also includes compounds of formula IV

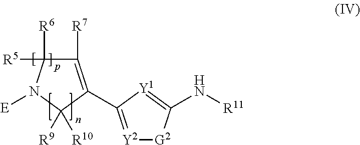

wherein E is hydrogen, a protecting group such as alkylcarbonyl, benzyl or alkoxycarbonyl, e.g. C₁-C₄ alkylcarbonyl, benzyl or C₁-C₄ alkoxycarbonyl, in particular acetyl, benzyl or tert-butoxycarbonyl; or group M

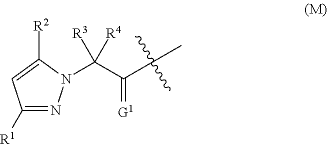

and G¹, G², Y¹, Y², n, p, R¹, R², R³, R⁴, R⁵, R⁶, R⁷, R⁹, R¹⁰ and R¹¹ are as defined for a compound of formula I. These compounds, including salts and N-oxides thereof, are useful as intermediates in the synthesis of compounds of formula I. Preferred definitions of G¹, G², Y¹, Y², n, p, R¹, R², R³, R⁴, R⁵, R⁶, R⁷, R⁹, R¹⁰ and R¹¹ are as defined for formula I.

Preferred individual compounds of formula I are:
3,5-Dichloro-2-hydroxy-N-(4-{1-[2-(5-methyl-3-trifluoromethyl-pyrazol-1-yl)-acetyl]piperidin-4-yl}-thiazol-2-yl)-benzamide;
Acetic acid 2,4-dichloro-6-(4-{1-[2-(5-methyl-3-trifluoromethyl-pyrazol-1-yl)-acetyl]piperidin-4-yl}-thiazol-2-ylcarbamoyl)-phenyl ester;
3-Chloro-2-hydroxy-N-(4-{1-[2-(5-methyl-3-trifluoromethyl-pyrazol-1-yl)-acetyl]piperidin-4-yl}thiazol-2-yl)-benzamide;
Acetic acid 2-chloro-6-(4-{1-[2-(5-methyl-3-trifluoromethyl-pyrazol-1-yl)-acetyl]-piperidin-4-yl}-thiazol-2-ylcarbamoyl)-phenyl ester;
2-(2-Chloro-6-fluoro-phenyl)-N-(4-{1-[2-(5-methyl-3-trifluoromethyl-pyrazol-1-yl)-acetyl]-piperidin-4-yl}-thiazol-2-yl)-acetamide;
1,2,3,4-Tetrahydro-naphthalene-1-carboxylic acid (4-{1-[2-(5-methyl-3-trifluoromethyl-pyrazol-1-yl)-acetyl]-piperidin-4-yl}-thiazol-2-yl)amide;
N-(4-{1-[2-(3,5-Bis-difluoromethyl-pyrazol-1-yl)-acetyl]piperidin-4-yl}thiazol-2-yl)-3,5-dichloro-2-hydroxy-benzamide;
Acetic acid 2-(4-{1-[2-(3,5-bis-difluoromethyl-pyrazol-1-yl)-acetyl]piperidin-4-yl}-thiazol-2-ylcarbamoyl)-4,6-dichloro-phenyl ester;
N-(4-{1-[2-(3,5-Bis-difluoromethyl-pyrazol-1-yl)-acetyl]-piperidin-4-yl}-thiazol-2-yl)-3-chloro-2-hydroxy-benzamide;
Acetic acid 2-(4-{1-[2-(3,5-bis-difluoromethyl-pyrazol-1-yl)-acetyl]piperidin-4-yl}-thiazol-2-ylcarbamoyl)-6-chloro-phenyl ester;
N-(4-{1-[2-(3,5-Bis-difluoromethyl-pyrazol-1-yl)-acetyl]-piperidin-4-yl}-thiazol-2-yl)-2-(2-chloro-6-fluoro-phenyl)-acetamide; and
1,2,3,4-Tetrahydro-naphthalene-1-carboxylic acid (4-{1-[2-(3,5-bis-difluoromethyl-pyrazol-1-yl)-acetyl]-piperidin-4-yl}-thiazol-2-yl)-amide.

Compounds of the present invention can be made as shown in the following schemes. Throughout this description, the group M, wherein R¹, R², R³, R⁴ and G¹ are as defined for formula I, stands for:

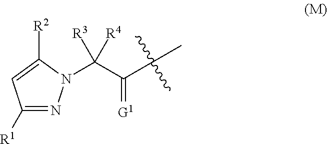

The compounds of formula VI, wherein R⁵, R⁶, R⁷, R⁸, R⁹, R¹⁰, R¹¹, R¹², G², G³, T, Y¹, Y², n, and p are as defined for formula I and E is hydrogen, a protecting group such as acetyl, benzyl or tert-butoxycarbonyl or a group M, can be obtained by transformation of a compound of formula III, wherein R⁵, R⁶, R⁷, R⁸, R⁹, R¹⁰, R¹¹, G², T, Y¹, Y², n and p are as defined for formula I and E is hydrogen, a protecting group such as acetyl, benzyl or tert-butoxycarbonyl or a group M, with a compound of formula V, wherein R¹² and G³ are as defined for formula I and R¹⁹ is hydroxy, halogen, preferably fluoro, chloro or bromo, or alkoxy, such as methoxy or ethoxy. This is shown in Scheme 1.

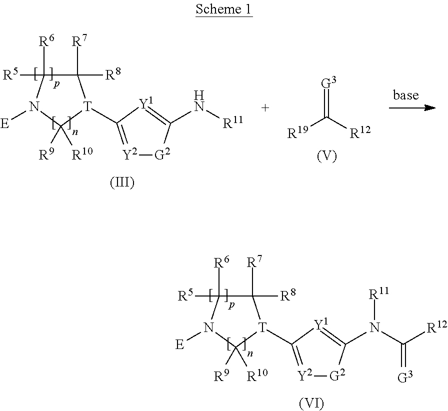

The compounds of formula III.a, wherein R⁵, R⁶, R⁷, R⁸, R⁹, R¹⁰, R¹¹, G², Y¹, Y², n and p are as defined for formula I and E is hydrogen, a protecting group such as acetyl, benzyl or tert-butoxycarbonyl or a group M, can be obtained by transformation of a compound of formula VII, wherein R⁵, R⁶, R⁷, R⁸, R⁹, R¹⁰, n and p are as defined for formula I and E is hydrogen, a protecting group such as acetyl, benzyl or tert-butoxycarbonyl or a group M, with a compound of formula VIII, wherein R¹¹, G², Y¹ and Y² are as defined for formula I and Hal is halogen, preferably chloro or bromo. This is shown in Scheme 2.

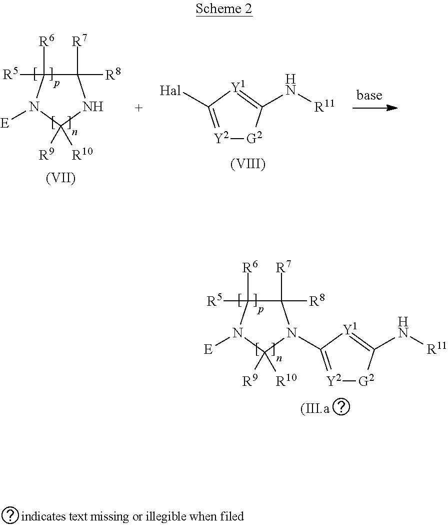

Alternatively the compounds of formula III.a, wherein R⁵, R⁶, R⁷, R⁸, R⁹, R¹⁰, R¹¹, G², Y¹, Y², n and p are as defined for formula I and E is hydrogen, a protecting group such as acetyl, benzyl or tert-butoxycarbonyl or a group M, can be obtained by transformation of a compound of formula IX, wherein R⁵, R⁶, R⁷, R⁸, R⁹, R¹⁰, G², Y¹, Y², n and p are as defined for formula I, Hal is halogen, preferably chloro or bromo and E is hydrogen, a protecting group such as acetyl, benzyl or tert-butoxycarbonyl or a group M, with a compound of formula X, wherein R¹¹ is as defined for formula I and Hal is halogen, preferably chloro or bromo. This is shown in Scheme 3.

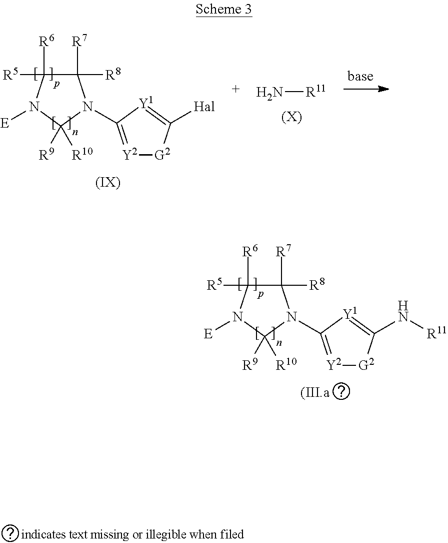

The compounds of formula IX, wherein R⁵, R⁶, R⁷, R⁸, R⁹, R¹⁰, R¹¹, G², Y¹, Y², n and p are as defined for formula I, Hal is halogen, preferably chloro or bromo and E is hydrogen, a protecting group such as acetyl, benzyl or tert-butoxycarbonyl or a group M, can be obtained by transformation of a compound of formula VII, wherein R⁵, R⁶, R⁷, R⁸, R⁹, R¹⁰, n and p are as defined for formula I and E is hydrogen, a protecting group such as acetyl, benzyl or tert-butoxycarbonyl or a group M, with a compound of formula XI, wherein G², Y¹ and Y² are as defined for formula I and Hal is halogen, preferably chloro or bromo. This is shown in Scheme 4.

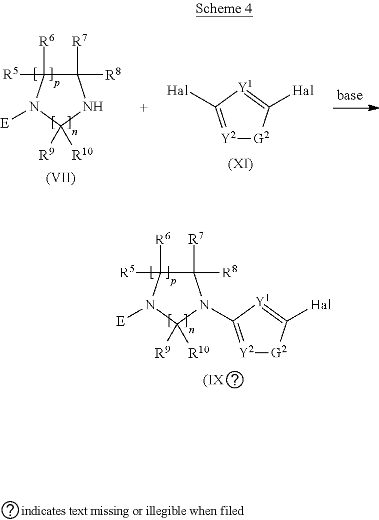

The compounds of formula III.b, wherein R⁵, R⁶, R⁷, R⁸, R⁹, R¹⁰, R¹¹, G², Y¹, Y², n and p are as defined for formula I and E is hydrogen, a protecting group such as acetyl, benzyl or tert-butoxycarbonyl or a group M, can be obtained by transformation of a compound of formula IV, wherein R⁵, R⁶, R⁷, R⁸, R⁹, R¹⁰, R¹¹, G², T, Y¹, Y², n and p are as defined for formula I and E is hydrogen, a protecting group such as acetyl, benzyl or tert-butoxycarbonyl or a group M. This is shown in Scheme 5

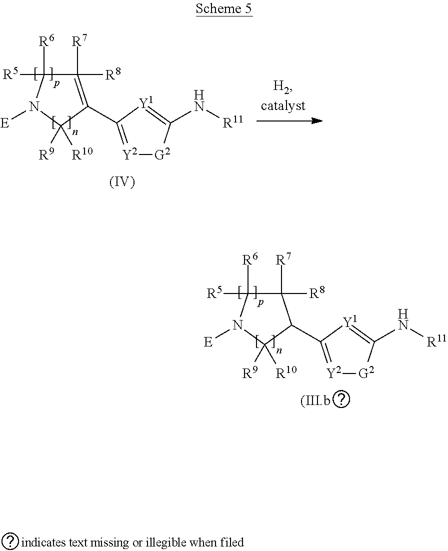

The compounds of formula IV, wherein R⁵, R⁶, R⁷, R⁸, R⁹, R¹⁰, R¹¹, G², T, Y¹, Y², n and p are as defined for formula I and E is hydrogen, a protecting group such as acetyl, benzyl or tert-butoxycarbonyl or a group M, can be obtained by transformation of a compound of formula XII, wherein R⁵, R⁶, R⁷, R⁸, R⁹, R¹⁰, n and p are as defined for formula I, R²⁰ is B(OH)₂ or an cyclic or acyclic ester of such a boronic acid, and E is hydrogen, a protecting group such as acetyl, benzyl or tert-butoxycarbonyl or a group M, with a compound of formula VIII, wherein R¹¹, G², Y¹ and Y² are as defined for formula I and Hal is halogen, preferably chloro or bromo. This is shown in Scheme 6

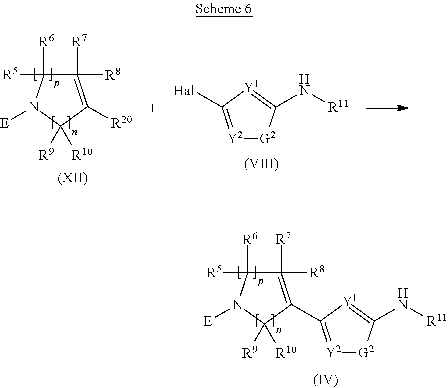

Alternatively the compounds of formula IV, wherein R⁵, R⁶, R⁷, R⁸, R⁹, R¹⁰, R¹¹, G², Y¹, Y², n and p are as defined for formula I and E is hydrogen, a protecting group such as acetyl, benzyl or tert-butoxycarbonyl or a group M, can be obtained by transformation of a compound of formula XIII, wherein R⁵, R⁶, R⁷, R⁸, R⁹, R¹⁰, G², Y¹, Y², n and p are as defined for formula I, Hal is halogen, preferably chloro or bromo and E is hydrogen, a protecting group such as acetyl, benzyl or tert-butoxycarbonyl or a group M, with a compound of formula X, wherein R¹¹ is as defined for formula I and Hal is halogen, preferably chloro or bromo. This is shown in Scheme 7

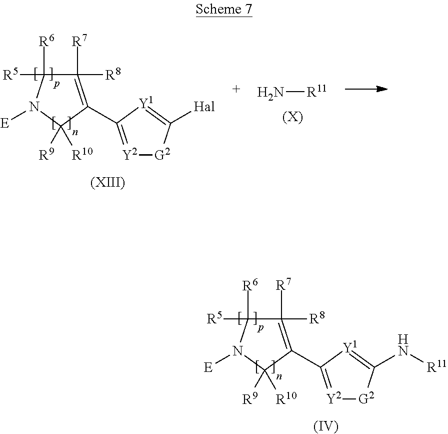

The compounds of formula XIII, wherein R⁵, R⁶, R⁷, R⁸, R⁹, R¹⁰, R¹¹, G², Y¹, Y², n and p are as defined for formula I, Hal is halogen, preferably chloro or bromo and E is hydrogen, a protecting group such as acetyl, benzyl or tert-butoxycarbonyl or a group M, can be obtained by transformation of a compound of formula XII, wherein R⁵, R⁶, R⁷, R⁸, R⁹, R¹⁰, n and p are as defined for formula I, R²⁰ is B(OH)₂ or an cyclic or acyclic ester of such a boronic acid, and E is hydrogen, a protecting group such as acetyl, benzyl or tert-butoxycarbonyl or a group M, with a compound of formula XI, wherein G², Y¹ and Y² are as defined for formula I and Hal is halogen, preferably chloro or bromo. This is shown in Scheme 8.

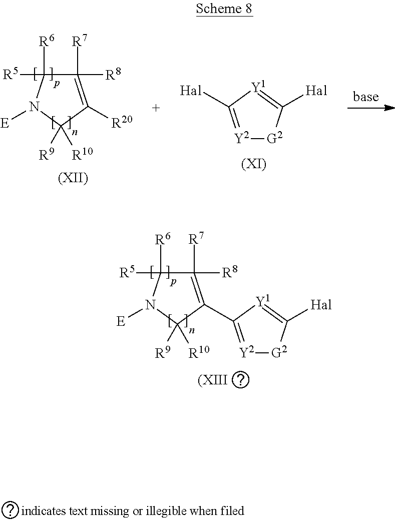

The compounds of formula III.c, wherein R⁵, R⁶, R⁷, R⁸, R⁹, R¹⁰, R¹¹, Y¹, n and p are as defined for formula I and E is hydrogen, a protecting group such as acetyl, benzyl or tert-butoxycarbonyl or a group M, can be obtained by transformation of a compound of formula XIV, wherein R⁵, R⁶, R⁷, R⁸, R⁹, R¹⁰, n and p are as defined for formula I, Hal is halogen, preferably chloro or bromo, and E is hydrogen, a protecting group such as acetyl, benzyl or tert-butoxycarbonyl or a group M, with a compound of formula XV, wherein R¹¹ is as defined for formula I. This is shown in Scheme 9.

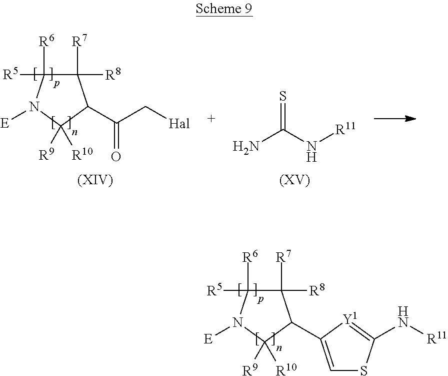

The compounds of formula VIII, wherein R¹¹, G², Y¹ and Y² are as defined for formula I can be obtained by transformation of a compound of formula XI, wherein G², Y¹ and Y² are as defined for formula I, with a compound of formula X, wherein R¹¹ is as defined for formula I. This is shown in Scheme 10.

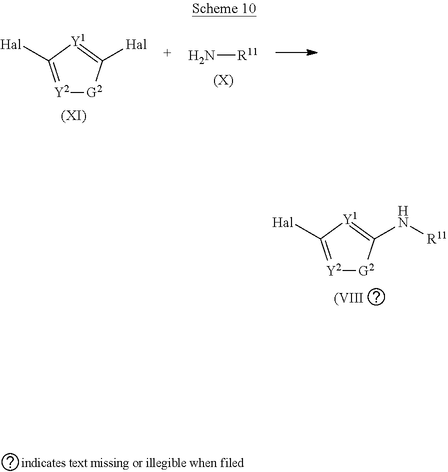

The compounds of formula VI.a, wherein R⁵, R⁶, R⁷, R⁸, R⁹, R¹⁰, R¹¹, R¹², G², Y¹, Y², n and p are as defined for formula I and E is hydrogen, a protecting group such as acetyl, benzyl or tert-butoxycarbonyl or a group M, can be obtained by transformation of a compound of formula VII, wherein R⁵, R⁶, R⁷, R⁸, R⁹, R¹⁰, n and p are as defined for formula I and E is hydrogen, a protecting group such as acetyl, benzyl or tert-butoxycarbonyl or a group M, with a compound of formula XVI, wherein R¹¹, R¹², G², Y¹ and Y² are as defined for formula I and Hal is halogen, preferably chloro or bromo. This is shown in Scheme 11.

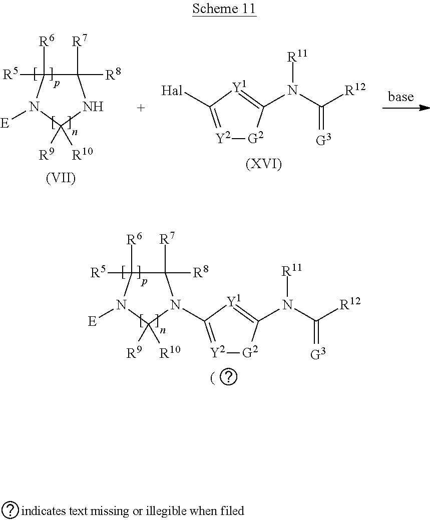

The compounds of formula VI.b, wherein R⁵, R⁶, R⁷, R⁸, R⁹, R¹⁰, R¹¹, R¹², G², Y¹, Y², n and p are as defined for formula I and E is hydrogen, a protecting group such as acetyl, benzyl or tert-butoxycarbonyl or a group M, can be obtained by transformation of a compound of formula XVII, wherein R⁵, R⁶, R⁷, R⁸, R⁹, R¹⁰, R¹¹, R¹², G², T, Y¹, Y², n and p are as defined for formula I and E is hydrogen, a protecting group such as acetyl, benzyl or tert-butoxycarbonyl or a group M. This is shown in Scheme 12.

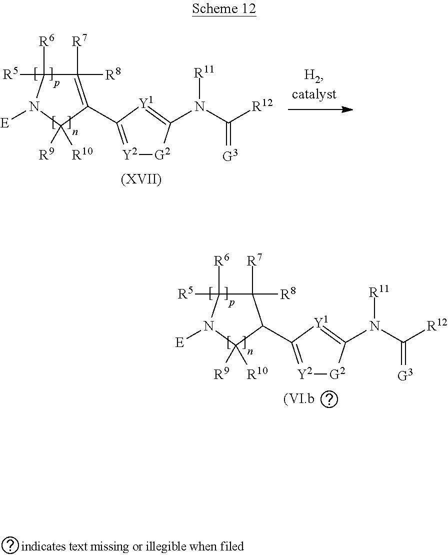

The compounds of formula XVII, wherein R⁵, R⁶, R⁷, R⁸, R⁹, R¹⁰, R¹¹, R¹², G², T, Y¹, Y², n and p are as defined for formula I and E is hydrogen, a protecting group such as acetyl, benzyl or tert-butoxycarbonyl or a group M, can be obtained by transformation of a compound of formula XII, wherein R⁵, R⁶, R⁷, R⁸, R⁹, R¹⁰, n and p are as defined for formula I, R²⁰ is B(OH)₂ or an cyclic or acyclic ester of such a boronic acid, and E is hydrogen, a protecting group such as acetyl, benzyl or tert-butoxycarbonyl or a group M, with a compound of formula XVI, wherein R¹¹, G², Y¹ and Y² are as defined for formula I and Hal is halogen, preferably chloro or bromo. This is shown in Scheme 13.

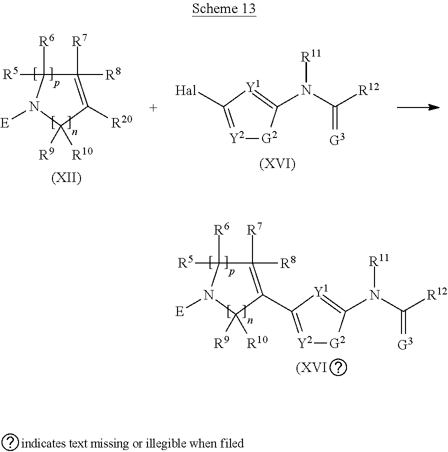

The compounds of formula XVI, wherein R¹¹, R¹², G², G³, Y¹ and Y² are as defined for formula I, can be obtained by transformation of a compound of formula VIII, wherein R¹¹, G², Y¹ and Y² are as defined for formula I, with a compound of formula V, wherein R¹² and G³ are as defined for formula I and R¹⁹ is hydroxy, halogen, preferably fluoro, chloro or bromo, or alkoxy, such as methoxy or ethoxy. This is shown in Scheme 14.

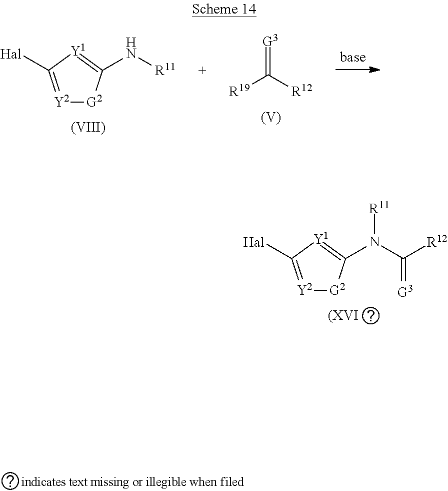

Surprisingly, it has now been found that the novel compounds of formula I have, for practical purposes, a very advantageous level of biological activity for protecting plants against diseases that are caused by fungi.

The compounds of formula I can be used in the agricultural sector and related fields of use e.g. as active ingredients for controlling plant pests or on non-living materials for control of spoilage microorganisms or organisms potentially harmful to man. The novel compounds are distinguished by excellent activity at low rates of application, by being well tolerated by plants and by being environmentally safe. They have very useful curative, preventive and systemic properties and may be used for protecting numerous cultivated plants. The compounds of formula I can be used to inhibit or destroy the pests that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula I as dressing agents for the treatment of plant propagation material, e.g., seed, such as fruits, tubers or grains, or plant cuttings (for example rice), for the protection against fungal infections as well as against phytopathogenic fungi occurring in the soil. The propagation material can be treated with a composition comprising a compound of formula I before planting: seed, for example, can be dressed before being sown. The active ingredients according to the invention can also be applied to grains (coating), either by impregnating the seeds in a liquid formulation or by coating them with a solid formulation. The composition can also be applied to the planting site when the propagation material is being planted, for example, to the seed furrow during sowing. The invention relates also to such methods of treating plant propagation material and to the plant propagation material so treated.

Furthermore the compounds according to present invention can be used for controlling fungi in related areas, for example in the protection of technical materials, including wood and wood related technical products, in food storage, in hygiene management.

In addition, the invention could be used to protect non-living materials from fungal attack, e.g. lumber, wall boards and paint.

The compounds of formula I are, for example, effective against the phytopathogenic fungi of the following classes: Fungi imperfecti (e.g. Alternaria spp.), Basidiomycetes (e.g. Corticium spp., Ceratobasidium spp., Waitea spp., Thanatephorus spp., Rhizoctonia spp., Hemileia spp., Puccinia spp., Phakopsora spp., Ustilago spp., Tilletia spp.), Ascomycetes (e.g. Venturia spp., Blumeria spp., Erysiphe spp., Podosphaera spp., Uncinula spp., Monilinia spp., Sclerotinia spp., Colletotrichum spp., Glomerella spp., Fusarium spp., Gibberella spp., Monographella spp., Phaeosphaeria spp., Mycosphaerella spp., Cercospora spp., Pyrenophora spp., Rhynchosporium spp., Magnaporthe spp., Gaeumannomyces spp., Oculimacula spp., Ramularia spp., Botryotinia spp.) and Oomycetes (e.g. Phytophthora spp., Pythium spp., Plasmopara spp., Peronospora spp., Pseudoperonospora spp. Bremia spp). Outstanding activity is observed against downy mildew (e.g. Plasmopara viticola) and late blight (e.g. Phytophthora infestans). Furthermore, the novel compounds of formula I are effective against phytopathogenic gram negative and gram positive bacteria (e.g. Xanthomonas spp, Pseudomonas spp, Erwinia amylovora, Ralstonia spp.) and viruses (e.g. tobacco mosaic virus).

Within the scope of present invention, target crops and/or useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as turf and ornamentals.

The useful plants and/or target crops in accordance with the invention include conventional as well as genetically enhanced or engineered varieties such as, for example, insect resistant (e.g. Bt. and VIP varieties) as well as disease resistant, herbicide tolerant (e.g. glyphosate- and glufosinate-resistant maize varieties commercially available under the trade names RoundupReady® and LibertyLink®) and nematode tolerant varieties. By way of example, suitable genetically enhanced or engineered crop varieties include the Stoneville 5599BR cotton and Stoneville 4892BR cotton varieties.

The term “useful plants” and/or “target crops” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” and/or “target crops” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

The term “useful plants” and/or “target crops” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a plant as used herein is intended to embrace the place on which the plants are growing, where the plant propagation materials of the plants are sown or where the plant propagation materials of the plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula I may be used in unmodified form or, preferably, together with the adjuvants conventionally employed in the art of formulation. To this end they may be conveniently formulated in known manner to emulsifiable concentrates, coatable pastes, directly sprayable or dilutable solutions or suspensions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants, e.g. for agricultural use, can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula I are normally used in the form of compositions and can be applied to the crop area or plant to be treated, simultaneously or in succession with further compounds. These further compounds can be e.g. fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation.

The compounds of formula I may be used in the form of (fungicidal) compositions for controlling or protecting against phytopathogenic microorganisms, comprising as active ingredient at least one compound of formula I or of at least one preferred individual compound as above-defined, in free form or in agrochemically usable salt form, and at least one of the above-mentioned adjuvants.

The invention provides a fungicidal composition comprising at least one compound formula I an agriculturally acceptable carrier and optionally an adjuvant. An agricultural acceptable carrier is for example a carrier that is suitable for agricultural use. Agricultural carriers are well known in the art. Preferably said fungicidal compositions may comprise at least one additional fungicidal active ingredient in addition to the compound of formula I.

The compound of formula (I) may be the sole active ingredient of a composition or it may be admixed with one or more additional active ingredients such as a pesticide, fungicide, synergist, herbicide or plant growth regulator where appropriate. An additional active ingredient may, in some cases, result in unexpected synergistic activities. Examples of suitable additional active ingredients include the following: Azoxystrobin (131860-33-8), Dimoxystrobin (149961-52-4), Enestrobin (238410-11-2), Fluoxastrobin (193740-76-0), Kresoxim-methyl (143390-89-0), Metominostrobin (133408-50-1), Orysastrobin (248593-16-0), Picoxystrobin (117428-22-5), Pyraclostrobin (175013-18-0), trifloxystrobin (141517-21-7), Azaconazole (60207-31-0), Bromuconazole (116255-48-2), Cyproconazole (94361-06-5), Difenoconazole (119446-68-3), Diniconazole (83657-24-3), Diniconazole-M (83657-18-5), Epoxiconazole (13385-98-8), Fenbuconazole (114369-43-6), Fluquinconazole (136426-54-5), Flusilazole (85509-19-9), Flutriafol (76674-21-0), Hexaconazole (79983-71-4), Imazalil (58594-72-2), Imibenconazole (86598-92-7), Ipconazole (125225-28-7), Metconazole (125116-23-6), Myclobutanil (88671-89-0), Oxpoconazole (174212-12-5), Pefurazoate (58011-68-0), Penconazole (66246-88-6), Prochloraz (67747-09-5), Propiconazole (60207-90-1), Prothioconazole (178928-70-6), Simeconazole (149508-90-7), Tebuconazole (107534-96-3), Tetraconazole (112281-77-3), Triadimefon (43121-43-3), Triadimenol (55219-65-3), Triflumizole (99387-89-0), Triticonazole (131983-72-7), Diclobutrazol (76738-62-0), Etaconazole (60207-93-4), Fluconazole (86386-73-4), Fluconazole-cis (112839-32-4), Thiabendazole (148-79-8), Quinconazole (103970-75-8), Fenpiclonil (74738-17-3), Fludioxonil (131341-86-1), Cyprodinil (121552-61-2), Mepanipyrim (110235-47-7), Pyrimethanil (53112-28-0), Aldimorph (91315-15-0), Dodemorph (1593-77-7), Fenpropimorph (67564-91-4), Tridemorph (81412-43-3), Fenpropidin (67306-00-7), Spiroxamine (118134-30-8), Isopyrazam (881685-58-1), Sedaxane (874967-67-6), Bixafen (581809-46-3), Penthiopyrad (183675-82-3), Fluxapyroxad (907204-31-3), Boscalid (188425-85-6), Penflufen (494793-67-8), Fluopyram (658066-35-4), Mandipropamid (374726-62-2), Benthiavalicarb (413615-35-7), Dimethomorph (110488-70-5), Chlorothalonil (1897-45-6), Fluazinam (79622-59-6), Dithianon (3347-22-6), Metrafenone (220899-03-6), Tricyclazole (41814-78-2), Mefenoxam (70630-17-0), Metalaxyl (57837-19-1), Acibenzolar (126448-41-7) (Acibenzolar-5-methyl (126448-41-7)), Mancozeb (8018-01-7), Ametoctradine (865318-97-4) Cyflufenamid (180409-60-3), Kresoxim-methyl (143390-89-0), Ipconazole (125225-28-7), Amisulbrom (348635-87-0), Cyflufenamid (180409-60-3), Ethaboxam (16650-77-3), Fluopicolide (239110-15-7), Fluthianil (304900-25-2), Isotianil (224049-04-1), Proquinazid (189278-12-4), Valiphenal (283159-90-0), 1-methyl-cyclopropene (3100-04-7), Trifloxystrobin (141517-21-7), Sulfur (7704-34-9), Copper ammoniumcarbonate (CAS 33113-08-5); Copper oleate (CAS 1120-44-1); Folpet (133-07-3), Quinoxyfen (124495-18-7), Captan (133-06-2), Fenhexamid (126833-17-8), Glufosinate and its salts (51276-47-2, 35597-44-5 (S-isomer)), Glyphosate (1071-83-6) and its salts (69254-40-6 (Diammonium), 34494-04-7 (Dimethylammonium), 38641-94-0 (Isopropylammonium), 40465-66-5 (Monoammonium), 70901-20-1 (Potassium), 70393-85-0 (Sesquisodium), 81591-81-3 (Trimesium)), 1-methyl-3-difluoromethyl-1H-pyrazole-4-carboxylic acid (2-dichloromethylene-3-ethyl-1-methyl-indan-4-yl)-amide (1072957-71-1), 1-methyl-3-difluoromethyl-1H-pyrazole-4-carboxylic acid (4′-methylsulfanyl-biphenyl-2-yl)-amide, 1-methyl-3-difluoromethyl-4H-pyrazole-4-carboxylic acid [2-(2,4-dichloro-phenyl)-2-methoxy-1-methyl-ethyl]-amide, (5-Chloro-2,4-dimethyl-pyridin-3-yl)-(2,3,4-trimethoxy-6-methyl-phenyl)-methanone, (5-Bromo-4-chloro-2-methoxy-pyridin-3-yl)-(2,3,4-trimethoxy-6-methyl-phenyl)-methanone, 2-{2-[(E)-3-(2,6-Dichloro-phenyl)-1-methyl-prop-2-en-(E)-ylideneaminooxymethyl]-phenyl}-2-[(Z)-methoxyimino]-N-methyl-acetamide, 3-[5-(4-Chloro-phenyl)-2,3-dimethyl-isoxazolidin-3-yl]-pyridine.

Another aspect of invention is related to the use of a compound of formula I or of a preferred individual compound as above-defined, of a composition comprising at least one compound of formula I or at least one preferred individual compound as above-defined, or of a fungicidal mixture comprising at least one compound of formula I or at least one preferred individual compound as above-defined, in admixture with other fungicides, as described above, for controlling or preventing infestation of plants, e.g. useful plants such as crop plants, propagation material thereof, e.g. seeds, harvested crops, e.g. harvested food crops, or non-living materials by phytopathogenic microorganisms, preferably fungal organisms.

A further aspect of invention is related to a method of controlling or preventing an infestation of plants, e.g. useful plants such as crop plants, propagation material thereof, e.g. seeds, harvested crops, e.g. harvested food crops, or of non-living materials by phytopathogenic or spoilage microorganisms or organisms potentially harmful to man, especially fungal organisms, which comprises the application of a compound of formula I or of a preferred individual compound as above-defined as active ingredient to the plants, to parts of the plants or to the locus thereof, to the propagation material thereof, or to any part of the non-living materials.

Controlling or preventing means reducing infestation by phytopathogenic or spoilage microorganisms or organisms potentially harmful to man, especially fungal organisms, to such a level that an improvement is demonstrated.

A preferred method of controlling or preventing an infestation of crop plants by phytopathogenic microorganisms, especially fungal organisms, which comprises the application of a compound of formula I, or an agrochemical composition which contains at least one of said compounds, is foliar application. The frequency of application and the rate of application will depend on the risk of infestation by the corresponding pathogen. However, the compounds of formula I can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula I may also be applied to seeds (coating) by impregnating the seeds or tubers either with a liquid formulation of the fungicide or coating them with a solid formulation.

A formulation, e.g. a composition containing the compound of formula I, and, if desired, a solid or liquid adjuvant or monomers for encapsulating the compound of formula I, may be prepared in a known manner, typically by intimately mixing and/or grinding the compound with extenders, for example solvents, solid carriers and, optionally, surface active compounds (surfactants).

The agrochemical formulations and/or compositions will usually contain from 0.1 to 99% by weight, preferably from 0.1 to 95% by weight, of the compound of formula I, 99.9 to 1% by weight, preferably 99.8 to 5% by weight, of a solid or liquid adjuvant, and from 0 to 25% by weight, preferably from 0.1 to 25% by weight, of a surfactant.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient dosages are from 10 mg to 1 g of active substance per kg of seeds.

Whereas it is preferred to formulate commercial products as concentrates, the end user will normally use dilute formulations.

The following non-limiting example illustrates the above-described invention in more detail.

### EXAMPLE 1

This Example illustrates the preparation of 2-(2-chloro-6-fluoro-phenyl)-N-(4-{1-[2-(5-methyl-3-trifluoromethyl-pyrazol-1-yl)-acetyl]-piperidin-4-yl}-thiazol-2-yl)-acetamide (compound I.as.001)

### a) Preparation of 4-(2-amino-thiazol-4-yl)piperidine-1-carboxylic acid tert-butyl ester

A suspension of thiourea (7.7 g, 0.1 mol) in 520 ml of isopropanol is slowly added to a solution of 4-(2-bromo-acetyl)-piperidine-1-carboxylic acid tert-butyl ester (14.3 g, 50.5 mmol) in 260 ml of isopropanol. The reaction mixture is stirred for 1 h at room temperature and subsequently poured slowly into 500 ml of a 1 N aqueous sodium carbonate solution, keeping the temperature between 20 and 30° C. by ice cooling. After separation of the phases, the aqueous layer is extracted twice with ethyl acetate. The combined organic phase is washed with brine and with water, dried over sodium sulfate and evaporated to dryness, delivering directly 4-(2-amino-thiazol-4-yl)piperidine-1-carboxylic acid tert-butyl ester as beige crystals. ¹H-NMR (400 MHz, CDCl₃): δ=1.46 (s, 9H), 1.53 (dd, 2H), 1.95 (dd, 2H), 2.61-2.82 (m, 3H), 4.14 (bs, 2H), 4.88-4.93 (m, 2H), 6.09 (s, 1H). MS: m/z=284 (M+1).

### b) Preparation of 4-{2-[2-(2-chloro-6-fluoro-phenyl)-acetylamino]-thiazol-4-yl}-piperidine-1-carboxylic acid tert-butyl ester

To a solution of 4-(2-amino-thiazol-4-yl)-piperidine-1-carboxylic acid tert-butyl ester (1.4 g, 5.0 mmol) in 20 ml of N,N-dimethylformamide are added at 0° C. ethyl(diisopropyl)amine (2.5 g, 19 mmol), 2,chloro-6-fluorophenylacetic acid (1.0 g, 5.5 mmol) and benzotriazol-1-yloxy-tris(dimethylamino)-phosphonium hexafluorophosphate (2.4 g, 5.5 mmol). The reaction mixture is stirred for 16 h at room temperature and then evaporated. The remainder taken up with ethyl acetate, extracted with 1 N aqueous sodium bicarbonate solution, 0.5 N aqueous hydrochloric acid and brine, dried over sodium sulfate and evaporated. The residue is purified by column chromatography on silica gel (cyclohexane/ethyl acetate 3:1) to give 4-{2-[2-(2-chloro-6-fluoro-phenyl)-acetylamino]-thiazol-4-yl}-piperidine-1-carboxylic acid tert-butyl ester as beige foam. ¹H-NMR (400 MHz, CDCl₃): δ=1.48 (s, 9H), 1.54 (dd, 2H), 1.95 (dd, 2H), 2.68-2.87 (m, 3H), 4.00 (s, 2H), 4.19 (bs, 2H), 6.52 (s, 1H), 7.09 (t, 1H), 7.26-7.31 (m, 1H), 8.59 (s, 1H). MS: m/z=454 (M+1).

### c) Preparation of 2-(2-chloro-6-fluoro-phenyl)-N-(4-piperidin-4-yl-thiazol-2-yl)-acetamide hydrochloride

18 ml of a 1.25 M solution of hydrochloric acid in ethanol are added to a solution of 4-{2-[2-(2-chloro-6-fluoro-phenyl)-acetylamino]-thiazol-4-yl}-piperidine-1-carboxylic acid tert-butyl ester (1.0 g, 2.2 mmol) in 25 ml of 1:1 mixture of dichloromethane and methanol. This reaction mixture is stirred for 16 h at room temperature and then evaporated to directly give 2-(2-chloro-6-fluoro-phenyl)-N-(4-piperidin-4-yl-thiazol-2-yl)-acetamide hydrochloride as slightly yellow foam. ¹H-NMR (400 MHz, CDCl₃): δ=1.62 (dd, 2H), 2.01 (dd, 2H), 2.70-2.88 (m, 3H), 4.03 (s, 2H), 4.22 (s, 2H), 6.56 (s, 1H), 7.12 (t, 1H), 7.31-7.37 (m, 1H), 8.45 (s, 1H). MS: m/z=354 (M+1).

### d) Preparation of 2-(2-chloro-6-fluoro-phenyl)-N-(4-{1-[2-(5-methyl-3-trifluoromethyl-pyrazol-1-yl)-acetyl]-piperidin-4-yl}-thiazol-2-yl)-acetamide (compound I.as.001)

To a solution of 2-(2-chloro-6-fluoro-phenyl)-N-(4-piperidin-4-yl-thiazol-2-yl)-acetamide hydrochloride (0.43 g, 1.1 mmol) in 15 ml of N,N-dimethylformamide are added at 0° C. ethyl(diisopropyl)amine (0.35 g, 2.7 mmol), (5-methyl-3-trifluoromethyl-pyrazol-1-yl)-acetic acid (0.25 g, 1.2 mmol) and benzotriazol-1-yloxy-tris(dimethylamino)-phosphonium hexafluorophosphate (0.53 g, 1.2 mmol). The reaction mixture is stirred for 16 h at room temperature and then evaporated. The remainder taken up with ethyl acetate, extracted with 1 N aqueous sodium bicarbonate solution, 0.5 N aqueous hydrochloric acid and brine, dried over sodium sulfate and evaporated. The residue is purified by column chromatography on silica gel (cyclohexane/ethyl acetate 3:1) to give 2-(2-chloro-6-fluoro-phenyl)-N-(4-{1-[2-(5-methyl-3-trifluoromethyl-pyrazol-1-yl)-acetyl]piperidin-4-yl}-thiazol-2-yl)-acetamide (compound I.as.001) as white crystals. m.p. 249-251° C. ¹H-NMR (400 MHz, CDCl₃): δ=1.62 (dd, 2H), 2.04 (t, 2H), 2.30 (s, 3H), 2.71-2.88 (m, 2H), 3.22 (t, 2H), 3.96-4.03 (m, 3H), 4.60 (d, 1H), 4.99 (q, 2H), 6.32 (s, 1H), 6.53 (s, 1H), 7.11 (t, 1H), 7.28-7.33 (m, 2H), 8.66 (s, 1H). MS: m/z=544 (M+1).

Table 1 below illustrates examples of individual compounds of formula I according to the invention.

TABLE 1
individual compounds of formula I according to the invention

| Comp. | | | | | | | | | |
|---|---|---|---|---|---|---|---|---|---|
| No. | R¹ | R² | G¹ | T | Y¹ | G² | Y² | G³ | R¹¹ |
| 001 | F₃C | H₃C | O | CH | N | S | CH | O | H |
| 002 | F₃C | H₃C | O | CH | N | S | CH | O | CH₃ |
| 003 | F₃C | H₃C | O | CH | N | S | CH | S | H |
| 004 | F₃C | H₃C | O | CH | N | S | CH | S | CH₃ |
| 005 | F₃C | H₃C | O | CH | N | S | N | O | H |
| 006 | F₃C | H₃C | O | CH | N | S | N | O | CH₃ |
| 007 | F₃C | H₃C | O | CH | N | S | N | S | H |
| 008 | F₃C | H₃C | O | CH | N | S | N | S | CH₃ |
| 009 | F₃C | H₃C | O | CH | N | O | CH | O | H |
| 010 | F₃C | H₃C | O | CH | N | O | CH | O | CH₃ |
| 011 | F₃C | H₃C | O | CH | N | O | CH | S | H |
| 012 | F₃C | H₃C | O | CH | N | O | CH | S | CH₃ |
| 013 | F₃C | H₃C | O | N | N | S | CH | O | H |
| 014 | F₃C | H₃C | O | N | N | S | CH | O | CH₃ |
| 015 | F₃C | H₃C | O | N | N | S | CH | S | H |
| 016 | F₃C | H₃C | O | N | N | S | CH | S | CH₃ |
| 017 | F₃C | H₃C | O | N | N | S | N | O | H |
| 018 | F₃C | H₃C | O | N | N | S | N | O | CH₃ |
| 019 | F₃C | H₃C | O | N | N | S | N | S | H |
| 020 | F₃C | H₃C | O | N | N | S | N | S | CH₃ |
| 021 | F₃C | H₃C | O | N | N | O | CH | O | H |
| 022 | F₃C | H₃C | O | N | N | O | CH | O | CH₃ |
| 023 | F₃C | H₃C | O | N | N | O | CH | S | H |
| 024 | F₃C | H₃C | O | N | N | O | CH | S | CH₃ |
| 025 | F₃C | H₃C | S | CH | N | S | CH | O | H |
| 026 | F₃C | H₃C | S | CH | N | S | CH | O | CH₃ |
| 027 | F₃C | H₃C | S | CH | N | S | CH | S | H |
| 028 | F₃C | H₃C | S | CH | N | S | CH | S | CH₃ |
| 029 | F₃C | H₃C | S | CH | N | S | N | O | H |
| 030 | F₃C | H₃C | S | CH | N | S | N | O | CH₃ |
| 031 | F₃C | H₃C | S | CH | N | S | N | S | H |
| 032 | F₃C | H₃C | S | CH | N | S | N | S | CH₃ |
| 033 | F₃C | H₃C | S | CH | N | O | CH | O | H |
| 034 | F₃C | H₃C | S | CH | N | O | CH | O | CH₃ |
| 035 | F₃C | H₃C | S | CH | N | O | CH | S | H |
| 036 | F₃C | H₃C | S | CH | N | O | CH | S | CH₃ |
| 037 | F₃C | H₃C | S | N | N | S | CH | O | H |
| 038 | F₃C | H₃C | S | N | N | S | CH | O | CH₃ |
| 039 | F₃C | H₃C | S | N | N | S | CH | S | H |
| 040 | F₃C | H₃C | S | N | N | S | CH | S | CH₃ |
| 041 | F₃C | H₃C | S | N | N | S | N | O | H |
| 042 | F₃C | H₃C | S | N | N | S | N | O | CH₃ |
| 043 | F₃C | H₃C | S | N | N | S | N | S | H |
| 044 | F₃C | H₃C | S | N | N | S | N | S | CH₃ |
| 045 | F₃C | H₃C | S | N | N | O | CH | O | H |
| 046 | F₃C | H₃C | S | N | N | O | CH | O | CH₃ |
| 047 | F₃C | H₃C | S | N | N | O | CH | S | H |
| 048 | F₃C | H₃C | S | N | N | O | CH | S | CH₃ |
| 049 | H₃C | H₃C | O | CH | N | S | CH | O | H |
| 050 | H₃C | H₃C | O | CH | N | S | CH | O | CH₃ |
| 051 | H₃C | H₃C | O | CH | N | S | CH | S | H |
| 052 | H₃C | H₃C | O | CH | N | S | CH | S | CH₃ |
| 053 | H₃C | H₃C | O | CH | N | S | N | O | H |
| 054 | H₃C | H₃C | O | CH | N | S | N | O | CH₃ |
| 055 | H₃C | H₃C | O | CH | N | S | N | S | H |
| 056 | H₃C | H₃C | O | CH | N | S | N | S | CH₃ |
| 057 | H₃C | H₃C | O | CH | N | O | CH | O | H |
| 058 | H₃C | H₃C | O | CH | N | O | CH | O | CH₃ |
| 059 | H₃C | H₃C | O | CH | N | O | CH | S | H |
| 060 | H₃C | H₃C | O | CH | N | O | CH | S | CH₃ |
| 061 | H₃C | H₃C | O | N | N | S | CH | O | H |
| 062 | H₃C | H₃C | O | N | N | S | CH | O | CH₃ |
| 063 | H₃C | H₃C | O | N | N | S | CH | S | H |
| 064 | H₃C | H₃C | O | N | N | S | CH | S | CH₃ |
| 065 | H₃C | H₃C | O | N | N | S | N | O | H |
| 066 | H₃C | H₃C | O | N | N | S | N | O | CH₃ |
| 067 | H₃C | H₃C | O | N | N | S | N | S | H |
| 068 | H₃C | H₃C | O | N | N | S | N | S | CH₃ |
| 069 | H₃C | H₃C | O | N | N | O | CH | O | H |
| 070 | H₃C | H₃C | O | N | N | O | CH | O | CH₃ |
| 071 | H₃C | H₃C | O | N | N | O | CH | S | H |
| 072 | H₃C | H₃C | O | N | N | O | CH | S | CH₃ |
| 073 | H₃C | H₃C | S | CH | N | S | CH | O | H |
| 074 | H₃C | H₃C | S | CH | N | S | CH | O | CH₃ |
| 075 | H₃C | H₃C | S | CH | N | S | CH | S | H |
| 076 | H₃C | H₃C | S | CH | N | S | CH | S | CH₃ |
| 077 | H₃C | H₃C | S | CH | N | S | N | O | H |
| 078 | H₃C | H₃C | S | CH | N | S | N | O | CH₃ |
| 079 | H₃C | H₃C | S | CH | N | S | N | S | H |
| 080 | H₃C | H₃C | S | CH | N | S | N | S | CH₃ |
| 081 | H₃C | H₃C | S | CH | N | O | CH | O | H |
| 082 | H₃C | H₃C | S | CH | N | O | CH | O | CH₃ |
| 083 | H₃C | H₃C | S | CH | N | O | CH | S | H |
| 084 | H₃C | H₃C | S | CH | N | O | CH | S | CH₃ |
| 085 | H₃C | H₃C | S | N | N | S | CH | O | H |
| 086 | H₃C | H₃C | S | N | N | S | CH | O | CH₃ |
| 087 | H₃C | H₃C | S | N | N | S | CH | S | H |
| 088 | H₃C | H₃C | S | N | N | S | CH | S | CH₃ |
| 089 | H₃C | H₃C | S | N | N | S | N | O | H |
| 090 | H₃C | H₃C | S | N | N | S | N | O | CH₃ |
| 091 | H₃C | H₃C | S | N | N | S | N | S | H |
| 092 | H₃C | H₃C | S | N | N | S | N | S | CH₃ |
| 093 | H₃C | H₃C | S | N | N | O | CH | O | H |
| 094 | H₃C | H₃C | S | N | N | O | CH | O | CH₃ |
| 095 | H₃C | H₃C | S | N | N | O | CH | S | H |
| 096 | H₃C | H₃C | S | N | N | O | CH | S | CH₃ |
| 097 | Cl | H₃C | O | CH | N | S | CH | O | H |
| 098 | Cl | H₃C | O | CH | N | S | CH | O | CH₃ |
| 099 | Cl | H₃C | O | CH | N | S | CH | S | H |
| 100 | Cl | H₃C | O | CH | N | S | CH | S | CH₃ |
| 101 | Cl | H₃C | O | CH | N | S | N | O | H |
| 102 | Cl | H₃C | O | CH | N | S | N | O | CH₃ |
| 103 | Cl | H₃C | O | CH | N | S | N | S | H |
| 104 | Cl | H₃C | O | CH | N | S | N | S | CH₃ |
| 105 | Cl | H₃C | O | CH | N | O | CH | O | H |
| 106 | Cl | H₃C | O | CH | N | O | CH | O | CH₃ |
| 107 | Cl | H₃C | O | CH | N | O | CH | S | H |
| 108 | Cl | H₃C | O | CH | N | O | CH | S | CH₃ |
| 109 | Cl | H₃C | O | N | N | S | CH | O | H |
| 110 | Cl | H₃C | O | N | N | S | CH | O | CH₃ |
| 111 | Cl | H₃C | O | N | N | S | CH | S | H |
| 112 | Cl | H₃C | O | N | N | S | CH | S | CH₃ |
| 113 | Cl | H₃C | O | N | N | S | N | O | H |
| 114 | Cl | H₃C | O | N | N | S | N | O | CH₃ |
| 115 | Cl | H₃C | O | N | N | S | N | S | H |
| 116 | Cl | H₃C | O | N | N | S | N | S | CH₃ |
| 117 | Cl | H₃C | O | N | N | O | CH | O | H |
| 118 | Cl | H₃C | O | N | N | O | CH | O | CH₃ |
| 119 | Cl | H₃C | O | N | N | O | CH | S | H |
| 120 | Cl | H₃C | O | N | N | O | CH | S | CH₃ |
| 121 | Cl | H₃C | S | CH | N | S | CH | O | H |
| 122 | Cl | H₃C | S | CH | N | S | CH | O | CH₃ |
| 123 | Cl | H₃C | S | CH | N | S | CH | S | H |
| 124 | Cl | H₃C | S | CH | N | S | CH | S | CH₃ |
| 125 | Cl | H₃C | S | CH | N | S | N | O | H |
| 126 | Cl | H₃C | S | CH | N | S | N | O | CH₃ |
| 127 | Cl | H₃C | S | CH | N | S | N | S | H |
| 128 | Cl | H₃C | S | CH | N | S | N | S | CH₃ |
| 129 | Cl | H₃C | S | CH | N | O | CH | O | H |
| 130 | Cl | H₃C | S | CH | N | O | CH | O | CH₃ |
| 131 | Cl | H₃C | S | CH | N | O | CH | S | H |
| 132 | Cl | H₃C | S | CH | N | O | CH | S | CH₃ |
| 133 | Cl | H₃C | S | N | N | S | CH | O | H |
| 134 | Cl | H₃C | S | N | N | S | CH | O | CH₃ |
| 135 | Cl | H₃C | S | N | N | S | CH | S | H |
| 136 | Cl | H₃C | S | N | N | S | CH | S | CH₃ |
| 137 | Cl | H₃C | S | N | N | S | N | O | H |
| 138 | Cl | H₃C | S | N | N | S | N | O | CH₃ |
| 139 | Cl | H₃C | S | N | N | S | N | S | H |
| 140 | Cl | H₃C | S | N | N | S | N | S | CH₃ |
| 141 | Cl | H₃C | S | N | N | O | CH | O | H |
| 142 | Cl | H₃C | S | N | N | O | CH | O | CH₃ |
| 143 | Cl | H₃C | S | N | N | O | CH | S | H |
| 144 | Cl | H₃C | S | N | N | O | CH | S | CH₃ |
| 145 | F₂HC | H₃C | O | CH | N | S | CH | O | H |
| 146 | F₂HC | H₃C | O | CH | N | S | CH | O | CH₃ |
| 147 | F₂HC | H₃C | O | CH | N | S | CH | S | H |
| 148 | F₂HC | H₃C | O | CH | N | S | CH | S | CH₃ |
| 149 | F₂HC | H₃C | O | CH | N | S | N | O | H |
| 150 | F₂HC | H₃C | O | CH | N | S | N | O | CH₃ |
| 151 | F₂HC | H₃C | O | CH | N | S | N | S | H |
| 152 | F₂HC | H₃C | O | CH | N | S | N | S | CH₃ |
| 153 | F₂HC | H₃C | O | CH | N | O | CH | O | H |
| 154 | F₂HC | H₃C | O | CH | N | O | CH | O | CH₃ |
| 155 | F₂HC | H₃C | O | CH | N | O | CH | S | H |
| 156 | F₂HC | H₃C | O | CH | N | O | CH | S | CH₃ |
| 157 | F₂HC | H₃C | O | N | N | S | CH | O | H |
| 158 | F₂HC | H₃C | O | N | N | S | CH | O | CH₃ |
| 159 | F₂HC | H₃C | O | N | N | S | CH | S | H |
| 160 | F₂HC | H₃C | O | N | N | S | CH | S | CH₃ |
| 161 | F₂HC | H₃C | O | N | N | S | N | O | H |
| 162 | F₂HC | H₃C | O | N | N | S | N | O | CH₃ |
| 163 | F₂HC | H₃C | O | N | N | S | N | S | H |
| 164 | F₂HC | H₃C | O | N | N | S | N | S | CH₃ |
| 165 | F₂HC | H₃C | O | N | N | O | CH | O | H |
| 166 | F₂HC | H₃C | O | N | N | O | CH | O | CH₃ |
| 167 | F₂HC | H₃C | O | N | N | O | CH | S | H |
| 168 | F₂HC | H₃C | O | N | N | O | CH | S | CH₃ |
| 169 | F₂HC | H₃C | S | CH | N | S | CH | O | H |
| 170 | F₂HC | H₃C | S | CH | N | S | CH | O | CH₃ |
| 171 | F₂HC | H₃C | S | CH | N | S | CH | S | H |
| 172 | F₂HC | H₃C | S | CH | N | S | CH | S | CH₃ |
| 173 | F₂HC | H₃C | S | CH | N | S | N | O | H |
| 174 | F₂HC | H₃C | S | CH | N | S | N | O | CH₃ |
| 175 | F₂HC | H₃C | S | CH | N | S | N | S | H |
| 176 | F₂HC | H₃C | S | CH | N | S | N | S | CH₃ |
| 177 | F₂HC | H₃C | S | CH | N | O | CH | O | H |
| 178 | F₂HC | H₃C | S | CH | N | O | CH | O | CH₃ |
| 179 | F₂HC | H₃C | S | CH | N | O | CH | S | H |
| 180 | F₂HC | H₃C | S | CH | N | O | CH | S | CH₃ |
| 181 | F₂HC | H₃C | S | N | N | S | CH | O | H |
| 182 | F₂HC | H₃C | S | N | N | S | CH | O | CH₃ |
| 183 | F₂HC | H₃C | S | N | N | S | CH | S | H |
| 184 | F₂HC | H₃C | S | N | N | S | CH | S | CH₃ |
| 185 | F₂HC | H₃C | S | N | N | S | N | O | H |
| 186 | F₂HC | H₃C | S | N | N | S | N | O | CH₃ |
| 187 | F₂HC | H₃C | S | N | N | S | N | S | H |
| 188 | F₂HC | H₃C | S | N | N | S | N | S | CH₃ |
| 189 | F₂HC | H₃C | S | N | N | O | CH | O | H |
| 190 | F₂HC | H₃C | S | N | N | O | CH | O | CH₃ |
| 191 | F₂HC | H₃C | S | N | N | O | CH | S | H |
| 192 | F₂HC | H₃C | S | N | N | O | CH | S | CH₃ |
| 193 | F₂HC | F₂HC | O | CH | N | S | CH | O | H |
| 194 | F₂HC | F₂HC | O | CH | N | S | CH | O | CH₃ |
| 195 | F₂HC | F₂HC | O | CH | N | S | CH | S | H |
| 196 | F₂HC | F₂HC | O | CH | N | S | CH | S | CH₃ |
| 197 | F₂HC | F₂HC | O | CH | N | S | N | O | H |
| 198 | F₂HC | F₂HC | O | CH | N | S | N | O | CH₃ |
| 199 | F₂HC | F₂HC | O | CH | N | S | N | S | H |
| 200 | F₂HC | F₂HC | O | CH | N | S | N | S | CH₃ |
| 201 | F₂HC | F₂HC | O | CH | N | O | CH | O | H |
| 202 | F₂HC | F₂HC | O | CH | N | O | CH | O | CH₃ |
| 203 | F₂HC | F₂H | CO | CH | N | O | CH | S | H |
| 204 | F₂HC | F₂HC | O | CH | N | O | CH | S | CH₃ |
| 205 | F₂HC | F₂H | CO | N | N | S | CH | O | H |
| 206 | F₂HC | F₂H | CO | N | N | S | CH | O | CH₃ |
| 207 | F₂HC | F₂HC | O | N | N | S | CH | S | H |
| 208 | F₂HC | F₂HC | O | N | N | S | CH | S | CH₃ |
| 209 | F₂HC | F₂HC | O | N | N | S | N | O | H |
| 210 | F₂HC | F₂HC | O | N | N | S | N | O | CH₃ |
| 211 | F₂HC | F₂HC | O | N | N | S | N | S | H |
| 212 | F₂HC | F₂HC | O | N | N | S | N | S | CH₃ |
| 213 | F₂HC | F₂HC | O | N | N | O | CH | O | H |
| 214 | F₂HC | F₂HC | O | N | N | O | CH | O | CH₃ |
| 215 | F₂HC | F₂HC | O | N | N | O | CH | S | H |
| 216 | F₂HC | F₂HC | O | N | N | O | CH | S | CH₃ |
| 217 | F₂HC | F₂HC | S | CH | N | S | CH | O | H |
| 218 | F₂HC | F₂HC | S | CH | N | S | CH | O | CH₃ |
| 219 | F₂HC | F₂HC | S | CH | N | S | CH | S | H |
| 220 | F₂HC | F₂HC | S | CH | N | S | CH | S | CH₃ |
| 221 | F₂HC | F₂HC | S | CH | N | S | N | O | H |
| 222 | F₂HC | F₂HC | S | CH | N | S | N | O | CH₃ |
| 223 | F₂HC | F₂HC | S | CH | N | S | N | S | H |
| 224 | F₂HC | F₂HC | S | CH | N | S | N | S | CH₃ |
| 225 | F₂HC | F₂HC | S | CH | N | O | CH | O | H |
| 226 | F₂HC | F₂HC | S | CH | N | O | CH | O | CH₃ |
| 227 | F₂HC | F₂HC | S | CH | N | O | CH | S | H |
| 228 | F₂HC | F₂HC | S | CH | N | O | CH | S | CH₃ |
| 229 | F₂HC | F₂HC | S | N | N | S | CH | O | H |
| 230 | F₂HC | F₂HC | S | N | N | S | CH | O | CH₃ |
| 231 | F₂HC | F₂HC | S | N | N | S | CH | S | H |
| 232 | F₂HC | F₂HC | S | N | N | S | CH | S | CH₃ |
| 233 | F₂HC | F₂HC | S | N | N | S | N | O | H |
| 234 | F₂HC | F₂HC | S | N | N | S | N | O | CH₃ |
| 235 | F₂HC | F₂HC | S | N | N | S | N | S | H |
| 236 | F₂HC | F₂HC | S | N | N | S | N | S | CH₃ |
| 237 | F₂HC | F₂HC | S | N | N | O | CH | O | H |
| 238 | F₂HC | F₂HC | S | N | N | O | CH | O | CH₃ |
| 239 | F₂HC | F₂HC | S | N | N | O | CH | S | H |
| 240 | F₂HC | F₂HC | S | N | N | O | CH | S | CH₃ |

where
a) 240 compounds of formula (I.a):

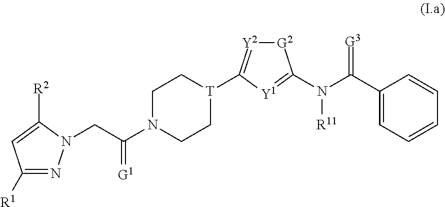

wherein R¹, R², R¹¹, G¹, G², G³, T, Y¹ and Y² are as defined in Table 1.
b) 240 compounds of formula (I.b):

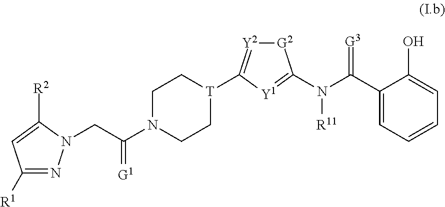

wherein R¹, R², R¹¹, G¹, G², G³, T, Y¹ and Y² are as defined in Table 1.
c) 240 compounds of formula (I.c):

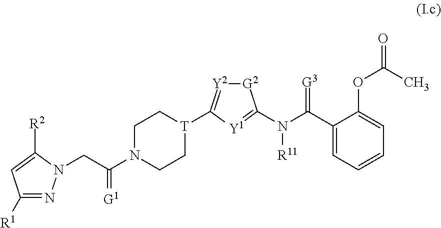

wherein R¹, R², R¹¹, G¹, G², G³, T, Y¹ and Y² are as defined in Table 1.
d) 240 compounds of formula (I.d):

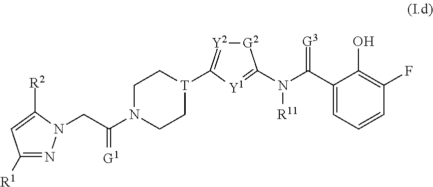

wherein R¹, R², R¹¹, G¹, G², G³, T, Y¹ and Y² are as defined in Table 1.
e) 240 compounds of formula (I.e):

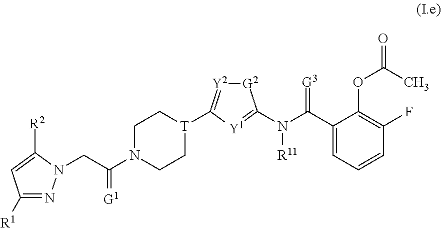

wherein R¹, R², R¹¹, G¹, G², G³, T, Y¹ and Y² are as defined in Table 1.
f) 240 compounds of formula (I.f):

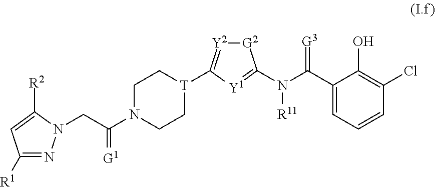

wherein R¹, R², R¹¹, G¹, G², G³, T, Y¹ and Y² are as defined in Table 1.
g) 240 compounds of formula (I.g):

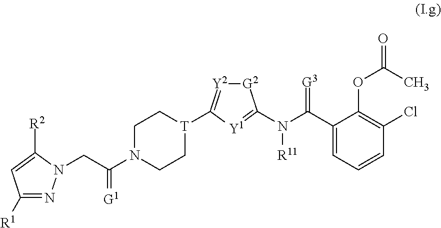

wherein R¹, R², R¹¹, G¹, G², G³, T, Y¹ and Y² are as defined in Table 1.
h) 240 compounds of formula (I.h):

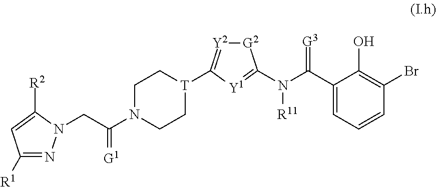

wherein R¹, R², R¹¹, G¹, G², G³, T, Y¹ and Y² are as defined in Table 1.
i) 240 compounds of formula (I.i):

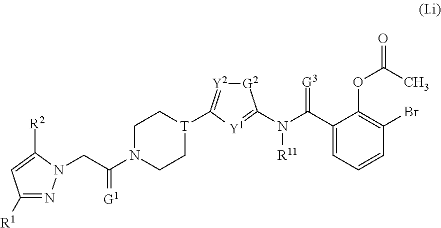

wherein R¹, R², R¹¹, G¹, G², G³, T, Y¹ and Y² are as defined in Table 1.
j) 240 compounds of formula (I.j):

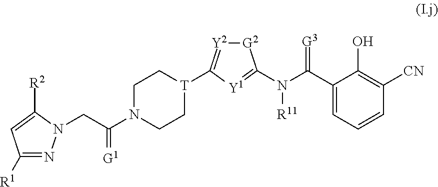

wherein R¹, R², R¹¹, G¹, G², G³, T, Y¹ and Y² are as defined in Table 1.
k) 240 compounds of formula (I.k):

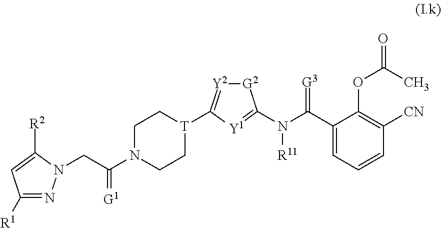

wherein R¹, R², R¹¹, G¹, G², G³, T, Y¹ and Y² are as defined in Table 1.
m) 240 compounds of formula (I.m):

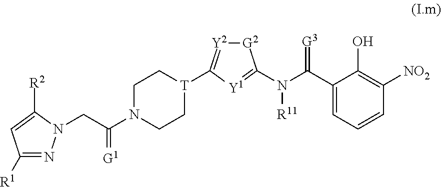

wherein R¹, R², R¹¹, G¹, G², G³, T, Y¹ and Y² are as defined in Table 1.
n) 240 compounds of formula (I.n):

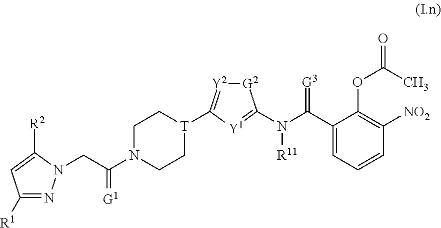

wherein R¹, R², R¹¹, G¹, G², G³, T, Y¹ and Y² are as defined in Table 1.
o) 240 compounds of formula (I.o):

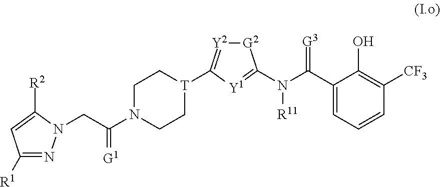

wherein R¹, R², R¹¹, G¹, G², G³, T, Y¹ and Y² are as defined in Table 1.
p) 240 compounds of formula (I.p):

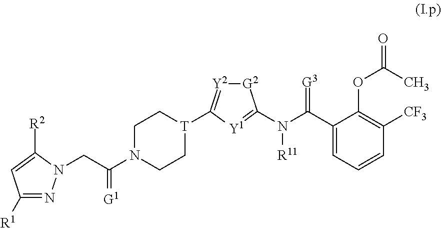

wherein R¹, R², R¹¹, G¹, G², G³, T, Y¹ and Y² are as defined in Table 1.
q) 240 compounds of formula (I.q):

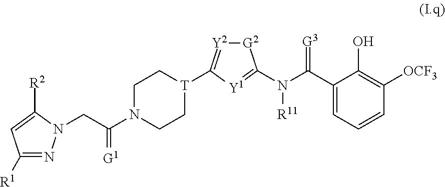

wherein R¹, R², R¹¹, G¹, G², G³, T, Y¹ and Y² are as defined in Table 1.
r) 240 compounds of formula (I.r):

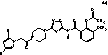

wherein R¹, R², R¹¹, G¹, G², G³, T, Y¹ and Y² are as defined in Table 1.
s) 240 compounds of formula (I.s):

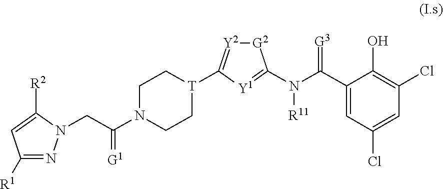

wherein R¹, R², R¹¹, G¹, G², G³, T, Y¹ and Y² are as defined in Table 1.
t) 240 compounds of formula (I.t):

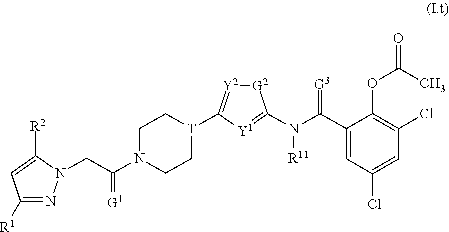

wherein R¹, R², R¹¹, G¹, G², G³, T, Y¹ and Y² are as defined in Table 1.
u) 240 compounds of formula (I.u):

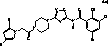

wherein R¹, R², R¹¹, G¹, G², G³, T, Y¹ and Y² are as defined in Table 1.
v) 240 compounds of formula (I.v):

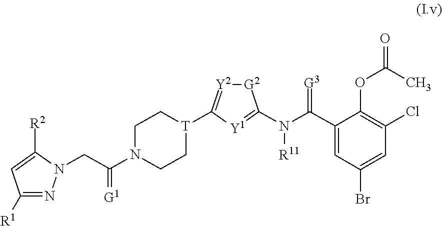

wherein R¹, R², R¹¹, G¹, G², G³, T, Y¹ and Y² are as defined in Table 1.
w) 240 compounds of formula (I.w):

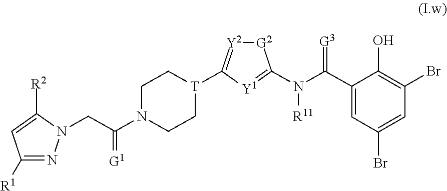

wherein R¹, R², R¹¹, G¹, G², G³, T, Y¹ and Y² are as defined in Table 1.
x) 240 compounds of formula (I.x):

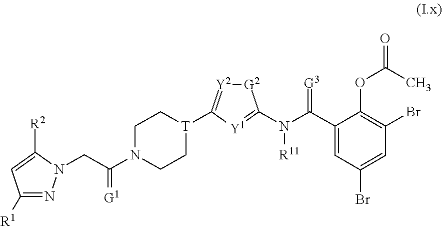

wherein R¹, R², R¹¹, G¹, G², G³, T, Y¹ and Y² are as defined in Table 1.
y) 240 compounds of formula (I.y):

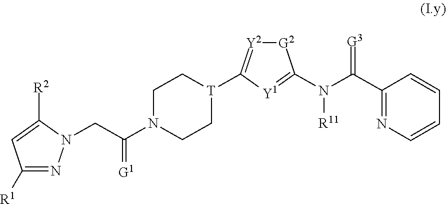

wherein R¹, R², R¹¹, G¹, G², G³, T, Y¹ and Y² are as defined in Table 1.
z) 240 compounds of formula (I.z):

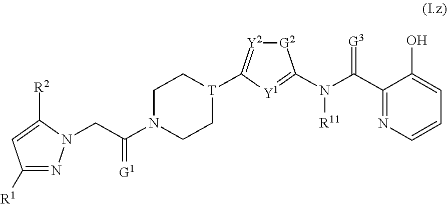

wherein R¹, R², R¹¹, G¹, G², G³, T, Y¹ and Y² are as defined in Table 1.
aa) 240 compounds of formula (I.aa):

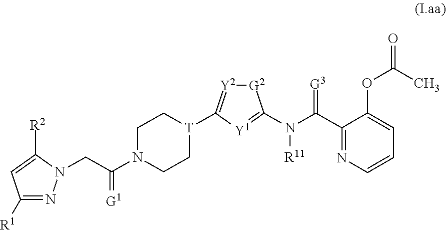

wherein R¹, R², R¹¹, G¹, G², G³, T, Y¹ and Y² are as defined in Table 1.
ab) 240 compounds of formula (I.ab):

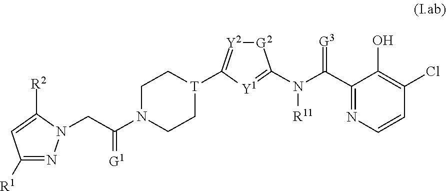

wherein R¹, R², R¹¹, G¹, G², G³, T, Y¹ and Y² are as defined in Table 1.
ac) 240 compounds of formula (I.ac):

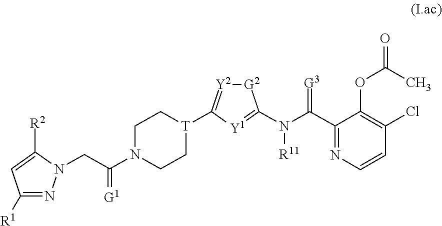

wherein R¹, R², R¹¹, G¹, G², G³, T, Y¹ and Y² are as defined in Table 1.
ad) 240 compounds of formula (I.ad):

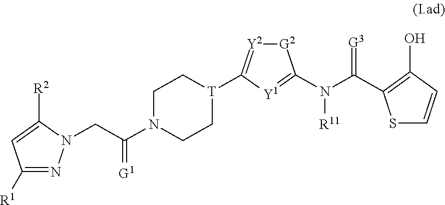

wherein R¹, R², R¹¹, G¹, G², G³, T, Y¹ and Y² are as defined in Table 1.
ae) 240 compounds of formula (I.ae):

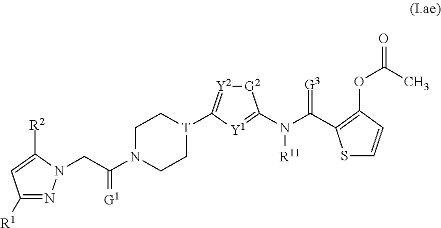

wherein R¹, R², R¹¹, G¹, G², G³, T, Y¹ and Y² are as defined in Table 1.
af) 240 compounds of formula (I.af):

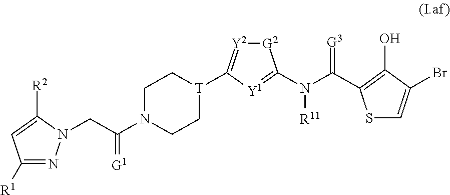

wherein R¹, R², R¹¹, G¹, G², G³, T, Y¹ and Y² are as defined in Table 1.
ag) 240 compounds of formula (I.ag):

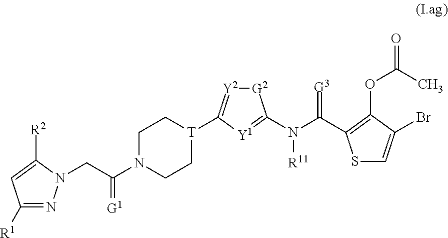

wherein R¹, R², R¹¹, G¹, G², G³, T, Y¹ and Y² are as defined in Table 1.
ah) 240 compounds of formula (I.ah):

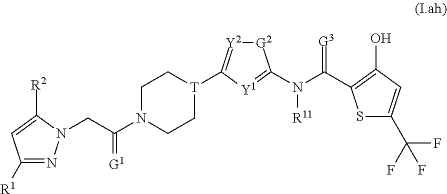

wherein R¹, R², R¹¹, G¹, G², G³, T, Y¹ and Y² are as defined in Table 1.
ai) 240 compounds of formula (I.ai):

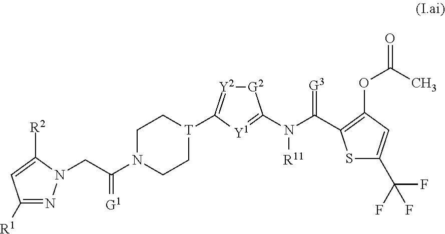

wherein R¹, R², R¹¹, G¹, G², G³, T, Y¹ and Y² are as defined in Table 1.
aj) 240 compounds of formula (I.aj):

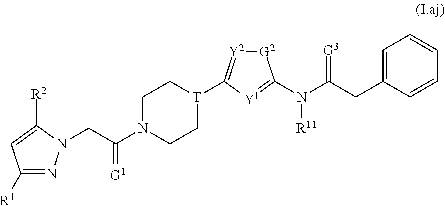

wherein R¹, R², R¹¹, G¹, G², G³, T, Y¹ and Y² are as defined in Table 1.
ak) 240 compounds of formula (I.ak):

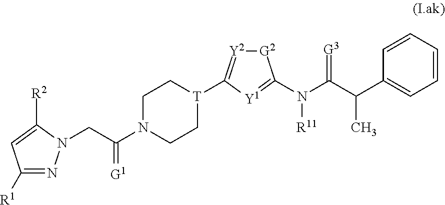

wherein R¹, R², R¹¹, G¹, G², G³, T, Y¹ and Y² are as defined in Table 1.
am) 240 compounds of formula (I.am):

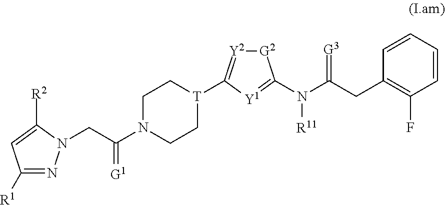

wherein R¹, R², R¹¹, G¹, G², G³, T, Y¹ and Y² are as defined in Table 1.
an) 240 compounds of formula (I.an):

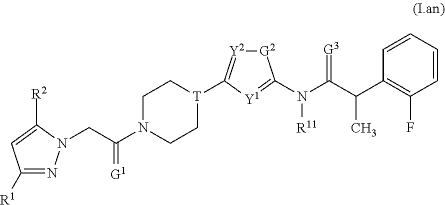

wherein R¹, R², R¹¹, G¹, G², G³, T, Y¹ and Y² are as defined in Table 1.
ao) 240 compounds of formula (I.ao):

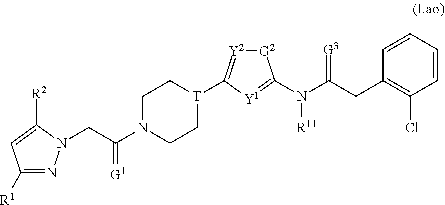

wherein R¹, R², R¹¹, G¹, G², G³, T, Y¹ and Y² are as defined in Table 1.
ap) 240 compounds of formula (I.ap):

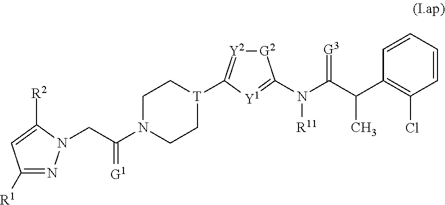

wherein R¹, R², R¹¹, G¹, G², G³, T, Y¹ and Y² are as defined in Table 1.
aq) 240 compounds of formula (I.aq):

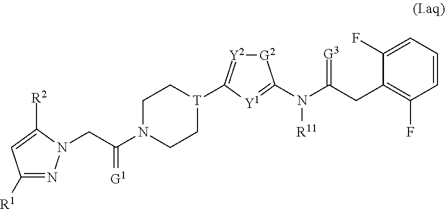

wherein R¹, R², R¹¹, G¹, G², G³, T, Y¹ and Y² are as defined in Table 1.
ar) 240 compounds of formula (I.ar):

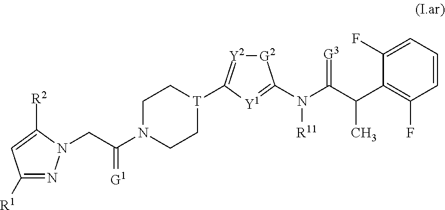

wherein R¹, R², R¹¹, G¹, G², G³, T, Y¹ and Y² are as defined in Table 1.
as) 240 compounds of formula (I.as):

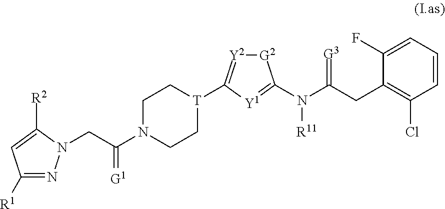

wherein R¹, R², R¹¹, G¹, G², G³, T, Y¹ and Y² are as defined in Table 1.
at) 240 compounds of formula (I.at):

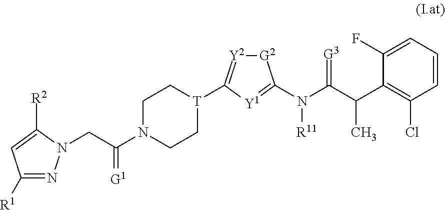

wherein R¹, R², R¹¹, G¹, G², G³, T, Y¹ and Y² are as defined in Table 1.
au) 240 compounds of formula (I.au):

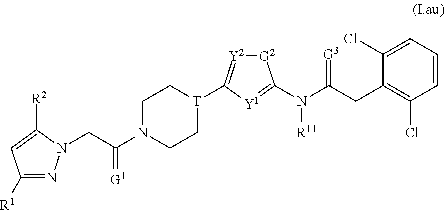

wherein R¹, R², R¹¹, G¹, G², G³, T, Y¹ and Y² are as defined in Table 1.
av) 240 compounds of formula (I.av):

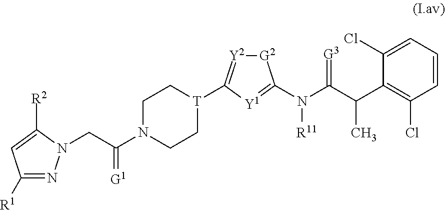

wherein R¹, R², R¹¹, G¹, G², G³, T, Y¹ and Y² are as defined in Table 1.
aw) 240 compounds of formula (I.aw):

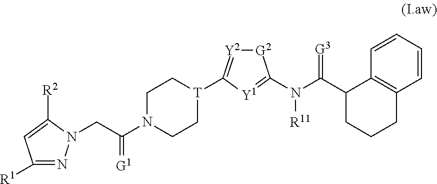

wherein R¹, R², R¹¹, G¹, G², G³, T, Y¹ and Y² are as defined in Table 1.
ax) 240 compounds of formula (I.ax):

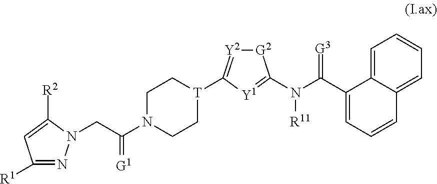

wherein R¹, R², R¹¹, G¹, G², G³, T, Y¹ and Y² are as defined in Table 1.
ay) 240 compounds of formula (I.ay):

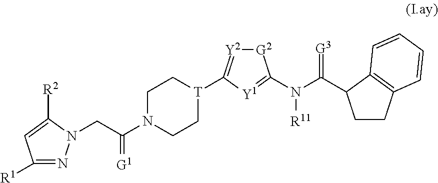

wherein R¹, R², R¹¹, G¹, G², G³, T, Y¹ and Y² are as defined in Table 1.
az) 240 compounds of formula (I.az):

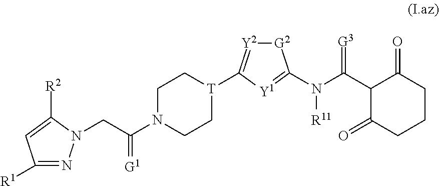

wherein R¹, R², R¹¹, G¹, G², G³, T, Y¹ and Y² are as defined in Table 1.
ba) 240 compounds of formula (I.ba):

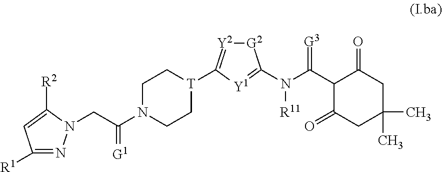

wherein R¹, R², R¹¹, G¹, G², G³, T, Y¹ and Y² are as defined in Table 1.
bb) 240 compounds of formula (I.bb):

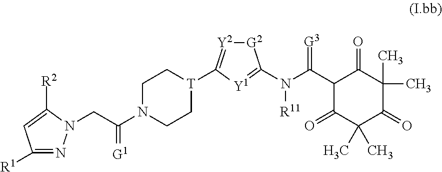

wherein R¹, R², R¹¹, G¹, G², G³, T, Y¹ and Y² are as defined in Table 1.
bc) 240 compounds of formula (I.bc):

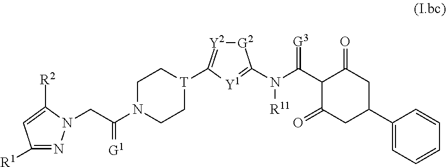

wherein R¹, R², R¹¹, G¹, G², G³, T, Y¹ and Y² are as defined in Table 1.
bd) 240 compounds of formula (I.bd):

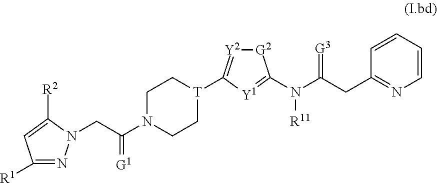

wherein R¹, R², R¹¹, G¹, G², G³, T, Y¹ and Y² are as defined in Table 1.
be) 240 compounds of formula (I.be):

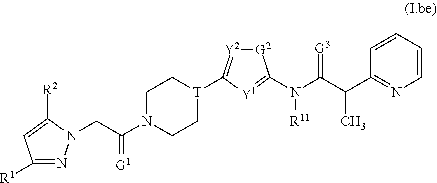

wherein R¹, R², R¹¹, G¹, G², G³, T, Y¹ and Y² are as defined in Table 1.
bf) 240 compounds of formula (I.bf):

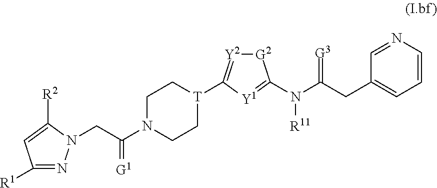

wherein R¹, R², R¹¹, G¹, G², G³, T, Y¹ and Y² are as defined in Table 1.
bg) 240 compounds of formula (I.bg):

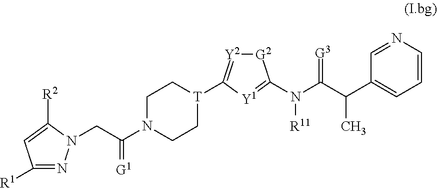

wherein R¹, R², R¹¹, G¹, G², G³, T, Y¹ and Y² are as defined in Table 1.
bh) 240 compounds of formula (I.bh):

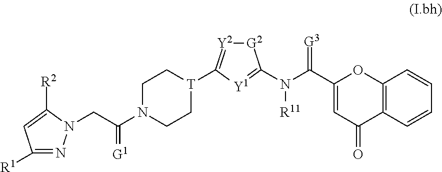

wherein R¹, R², R¹¹, G¹, G², G³, T, Y¹ and Y² are as defined in Table 1.
bi) 240 compounds of formula (I.bi):

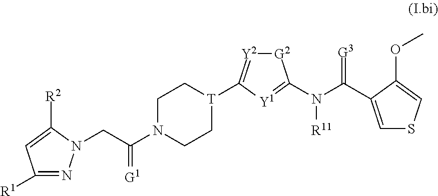

wherein R¹, R², R¹¹, G¹, G², G³, T, Y¹ and Y² are as defined in Table 1.
bj) 240 compounds of formula (I.bj):

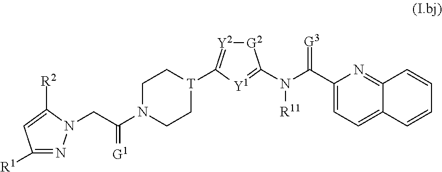

wherein R¹, R², R¹¹, G¹, G², G³, T, Y¹ and Y² are as defined in Table 1.
bk) 240 compounds of formula (I.bk):

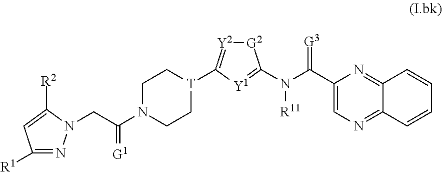

wherein R¹, R², R¹¹, G¹, G², G³, T, Y¹ and Y² are as defined in Table 1.
bm) 240 compounds of formula (I.bm):

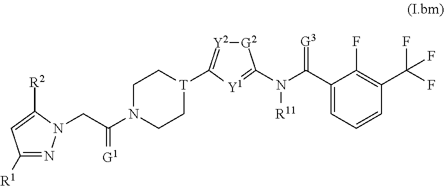

wherein R¹, R², R¹¹, G¹, G², G³, T, Y¹ and Y² are as defined in Table 1.
bn) 240 compounds of formula (I.bn):

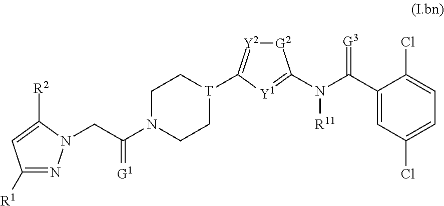

wherein R¹, R², R¹¹, G¹, G², G³, T, Y¹ and Y² are as defined in Table 1.
bo) 240 compounds of formula (I.bo):

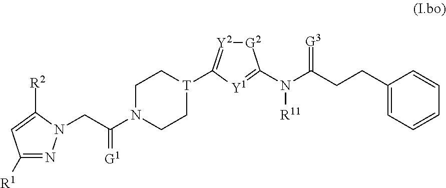

wherein R¹, R², R¹¹, G¹, G², G³, T, Y¹ and Y² are as defined in Table 1.
bp) 240 compounds of formula (I.bp):

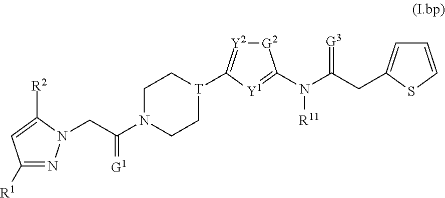

wherein R¹, R², R¹¹, G¹, G², G³, T, Y¹ and Y² are as defined in Table 1.
bq) 240 compounds of formula (I.bq):

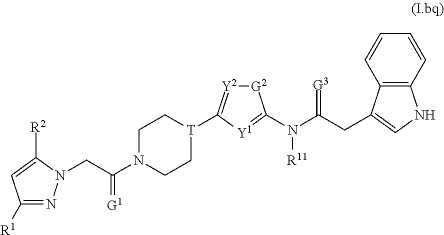

wherein R¹, R², R¹¹, G¹, G², G³, T, Y¹ and Y² are as defined in Table 1.
br) 240 compounds of formula (I.br):

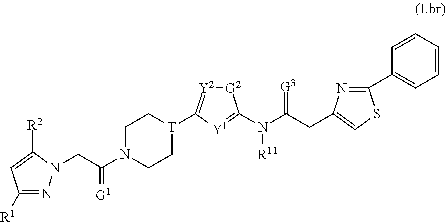

wherein R¹, R², R¹¹, G¹, G², G³, T, Y¹ and Y² are as defined in Table 1.
bs) 240 compounds of formula (I.bs):

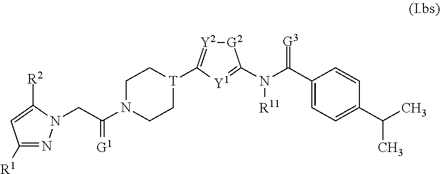

wherein R¹, R², R¹¹, G¹, G², G³, T, Y¹ and Y² are as defined in Table 1.
bt) 240 compounds of formula (I.bt):

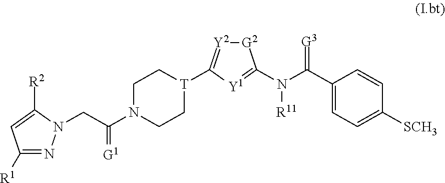

wherein R¹, R², R¹¹, G¹, G², G³, T, Y¹ and Y² are as defined in Table 1.
bu) 240 compounds of formula (I.bu):

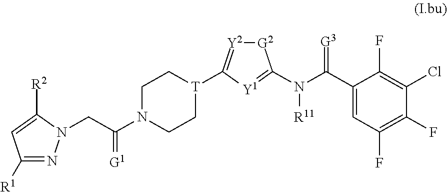

wherein R¹, R², R¹¹, G¹, G², G³, T, Y¹ and Y² are as defined in Table 1.
bv) 240 compounds of formula (I.bv):

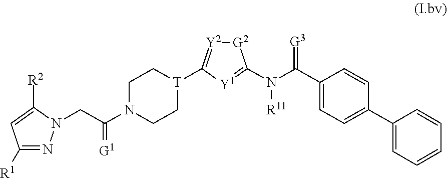

wherein R¹, R², R¹¹, G¹, G², G³, T, Y¹ and Y² are as defined in Table 1.
bw) 240 compounds of formula (I.bw):

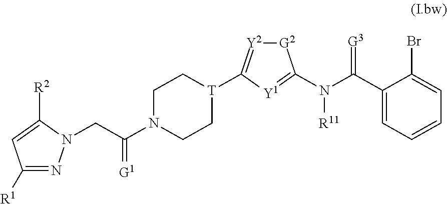

wherein R¹, R², R¹¹, G¹, G², G³, T, Y¹ and Y² are as defined in Table 1.
bx) 240 compounds of formula (I.bx):

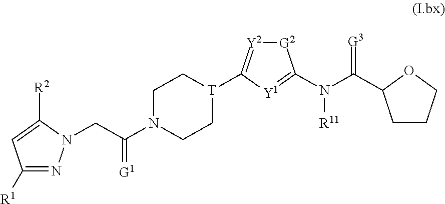

wherein R¹, R², R¹¹, G¹, G², G³, T, Y¹ and Y² are as defined in Table 1.
by) 240 compounds of formula (I.by):

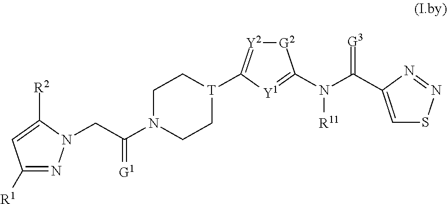

wherein R¹, R², R¹¹, G¹, G², G³, T, Y¹ and Y² are as defined in Table 1.
bz) 240 compounds of formula (I.bz):

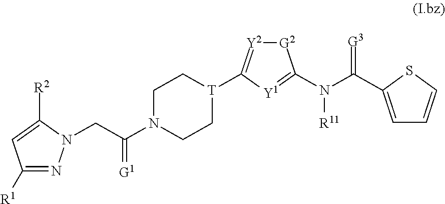

wherein R¹, R², R¹¹, G¹, G², G³, T, Y¹ and Y² are as defined in Table 1.

Throughout this description, temperatures are given in degrees Celsius and “m.p.” means melting point. LC/MS means Liquid Chromatography Mass Spectroscopy and the description of the apparatus and the method is: (ACQUITY UPLC from Waters, Phenomenex Gemini C18, 3 μm particle size, 110 Angström, 30×3 mm column, 1.7 mL/min., 60° C., H₂O+0.05% HCOOH (95%)/CH₃CN/MeOH 4:1+0.04% HCOOH (5%) 2 min. CH₃CN/MeOH 4:1+0.04% HCOOH (5%) 0.8 min., ACQUITY SQD Mass Spectrometer from Waters, ionization method: electrospray (ESI), Polarity: positive ions, Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700)).

TABLE 2
Melting point and LC/MS data for compounds of Table 1

| | Melting | |
|---|---|---|
| Compound No. | point (° C.) | LC/MS |
| I.f.001 | | Rt = 1.85 min; MS: m/z = 528 (M + 1) |
| I.g.001 | | Rt = 1.80 min; MS: m/z = 570 (M + 1) |
| I.s.001 | | Rt = 2.07 min; MS: m/z = 563 (M + 1) |
| I.t.001 | | Rt = 1.92 min; MS: m/z = 605 (M + 1) |
| I.as.001 | 249-251 | |
| I.aw.001 | | Rt = 1.88 min; MS: m/z = 532 (M + 1) |
| I.aj.001 | | Rt = 1.57 min; MS: m/z = 492 (M + 1) |
| I.ao.001 | | Rt = 1.63 min; MS: m/z = 526 (M + 1) |
| I.bh.001 | | Rt = 1.55 min; MS: m/z = 546 (M + 1) |
| I.bi.001 | | Rt = 1.61 min; MS: m/z = 514 (M + 1) |
| I.bj.001 | | Rt = 1.82 min; MS: m/z = 529 (M + 1) |
| I.bk.001 | | Rt = 1.67 min; MS: m/z = 530 (M + 1) |
| I.bm.001 | | Rt = 1.76 min; MS: m/z = 564 (M + 1) |
| I.bn.001 | | Rt = 1.73 min; MS: m/z = 546 (M + 1) |
| I.bo.001 | | Rt = 1.65 min; MS: m/z = 506 (M + 1) |
| I.bp.001 | | Rt = 1.53 min; MS: m/z = 498 (M + 1) |
| I.bq.001 | | Rt = 1.53 min; MS: m/z = 531 (M + 1) |
| I.br.001 | | Rt = 1.73 min; MS: m/z = 575 (M + 1) |
| I.bs.001 | | Rt = 1.87 min; MS: m/z = 520 (M + 1) |
| I.bt.001 | | Rt = 1.71 min; MS: m/z = 524 (M + 1) |
| I.bu.001 | | Rt = 1.81 min; MS: m/z = 566 (M + 1) |
| I.bv.001 | | Rt = 1.89 min; MS: m/z = 554 (M + 1) |
| I.bw.001 | | Rt = 1.60 min; MS: m/z = 558 (M + 3) |
| I.bx.001 | | Rt = 1.39 min; MS: m/z = 472 (M + 1) |
| I.by.001 | | Rt = 1.38 min; MS: m/z = 486 (M + 1) |
| I.bz.001 | | Rt = 1.54 min; MS: m/z = 484 (M + 1) |

The compounds according to the present invention can be prepared according to the above-mentioned reaction schemes, in which, unless otherwise stated, the definition of each variable is as defined above for a compound of formula (I).

### BIOLOGICAL EXAMPLES

### Phytophthora infestans/Tomato/Leaf Disc Preventative

### Tomato Late Blight

Tomato leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 16° C. and 75% rh under a light regime of 24 h darkness followed by 12 h light/12 h darkness in a climate cabinet and the activity of a compound is assessed as percent disease control compared to untreated when an appropriate level of disease damage appears in untreated check leaf disks (5-7 days after application).

Compounds I.f.001, I.g.001, I.s.001, I.t.001, I.as.001 and I.aw.001, I.aj.001, I.ao.001, I.bh.001, I.bi.001, I.bj.001, I.bk.001, I.bm.001, I.bn.001, I.bo.001, I.bp.001, I.bq.001, I.br.001, I.bs.001, I.bt.001, I.bu.001, I.bv.001, I.by.001, at 200 ppm give at least 80% disease control in this test when compared to untreated control leaf disks under the same conditions, which show extensive disease development.

Plasmopara viticola/Grape/Leaf Disc Preventative (Grape Downy Mildew)

Grape vine leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 19° C. and 80% rh under a light regime of 12 h light/12 h darkness in a climate cabinet and the activity of a compound is assessed as percent disease control compared to untreated when an appropriate level of disease damage appears in untreated check leaf disks (6-8 days after application).

Compounds I.f.001, I.g.001, I.s.001, I.t.001, I.as.001 and I.aw.001, I.aj.001, I.bh.001, I.bi.001, I.bj.001, I.bk.001, I.bm.001, I.bn.001, I.bo.001, I.bu.001, I.by.001 at 200 ppm give at least 80% disease control in this test when compared to untreated control leaf disks under the same conditions, which show extensive disease development.

Pythium ultimum/Liquid Culture (Seedling Damping Off)

Mycelia fragments and oospores of a newly grown liquid culture of the fungus are directly mixed into nutrient broth (PDB potato dextrose broth). After placing a (DMSO) solution of test compound into a microtiter plate (96-well format), the nutrient broth containing the fungal mycelia/spore mixture is added. The test plates are incubated at 24° C. and the inhibition of growth is determined photometrically 2-3 days after application.

Compounds I.f.001, I.g.001, I.s.001 and I.t.001, I.aj.001, I.bh.001, I.bi.001, I.bm.001, I.bn.001, at 200 ppm give at least 80% disease control in this test when compared to untreated control leaf disks under the same conditions, which show extensive disease development.

1. A compound of formula I: 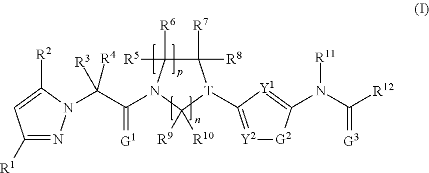
wherein
G¹, G² and G³ are independently O or S;
T is CR¹³ or N;
Y¹ and Y² are independently CR¹⁴ or N;
n is 1 or 2;
p is 1 or 2, providing that when n is 2, p is 1;
R¹, R², R³, R⁴, R⁵, R⁶, R⁷, R⁸, R⁹, R¹⁰, R¹³ and R¹⁴ each independently are hydrogen, halogen, cyano, C₁-C₄alkyl, C₃-C₅cycloalkyl or C₁-C₄haloalkyl;
R¹¹ is hydrogen, C₁-C₄alkyl, C₃-C₅cycloalkyl or C₁-C₄alkoxy;
R¹² is aryl optionally substituted by one or more R¹⁵, arylalkyl optionally substituted by one or more R¹⁵, a 7- to 11-membered isocyclic ring system optionally substituted by one or more R¹⁶, wherein the isocyclic ring system contains at least one aromatic cycle, heteroaryl optionally substituted by one or more R¹⁵, heteroarylalkyl optionally substituted by one or more R¹⁵, a 7- to 11-membered heterocyclic ring system optionally substituted by one or more R¹⁶, or group C-1 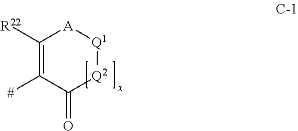
each R¹⁵ independently is halogen, cyano, amino, nitro, hydroxyl, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₄alkylcarboxy, C₃-C₈cycloalkylcarboxy, C₂-C₈alkenylcarboxy, C₂-C₈alkynylcarboxy, wherein alkyl, alkenyl, alkynyl, and cycloalkyl are optionally substituted by halogen, and wherein aryl and heterocyclyl are optionally substituted by one or more R¹⁷;
each R¹⁶ independently is halogen, cyano, amino, nitro, hydroxyl, oxo, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, C₁-C₄alkylcarboxy, C₃-C₈cycloalkylcarboxy, C₂-C₈alkenylcarboxy, C₂-C₈alkynylcarboxy, wherein alkyl, alkenyl, alkynyl and cycloalkyl are optionally substituted by halogen, and wherein aryl and heterocyclyl are optionally substituted by one or more R¹⁷;
each R¹⁷ independently is halogen, cyano, C₁-C₄alkyl, C₁-C₄haloalkyl, C₁-C₄alkoxy or C₁-C₄haloalkoxy;
A is C(R²⁵R²⁶), C(═O), C(═S), NR³¹, O or S;
Q¹ is C(R²⁷R²⁸), C(═O), C(═S), NR³¹, O or S;
Q² is C(R²⁹R³⁰), C(═O), C(═S), NR³¹, O or S;
R²² is hydroxyl, O⁻M⁺, OC(═O)R³⁵, amino or NHR³²;
x is 0 or 1, providing that when x is 1, Q¹ and Q² cannot both be oxygen;
M⁺ is a metal cation or ammonium cation;
R²⁵, R²⁶ R²⁷, R²⁸, R²⁹ and R³⁰ each independently are hydrogen, halogen, hydroxyl, amino, cyano, C₁-C₈alkyl, C₂-C₈alkenyl, C₂-C₈alkynyl, C₃-C₈cycloalkyl, C₁-C₈alkoxy, C₁-C₈alkylthio, C₁-C₈alkylsulfonyl, C₁-C₈alkylsulfinyl, aryl, heteroaryl or NHR²², wherein alkyl, alkenyl, alkynyl, cycloalkyl, aryl and heteroaryl are optionally substituted by one or more R³³; and wherein
R²⁵ and R²⁶, R²⁷ and R²⁸, and/or R²⁹ and R³⁰ may together form a saturated three- to six-membered alicyclic or heterocyclic ring wherein the aliyclic and heterocyclic rings are optionally substituted by one or more R³⁴; and/or
R²⁵ and R²⁷, and/or R²⁸ and R²⁹ may together form a saturated or partially unsaturated four- to seven-membered alicyclic or heterocyclic ring wherein the aliyclic and heterocyclic rings are optionally substituted by one or more R³⁴; and/or
R²⁵ and R²⁹ may together form a saturated or partially unsaturated four- to seven-membered alicyclic or heterocyclic ring wherein the aliyclic and heterocyclic rings are optionally substituted by one or more R³⁴;
R³¹ and R³² each independently are hydrogen, C₁-C₈alkyl, C₁-C₈haloalkyl C₂-C₈alkenyl, C₁-C₈haloalkenyl C₂-C₈alkynyl, C₂-C₈haloalkynyl, C₃-C₈cycloalkyl, C₃-C₈halocycloalkyl, C₁-C₈alkoxy, C₁-C₈haloalkoxy, C₁-C₈alkylcarbonyl, C₁-C₈haloalkylcarbonyl, C₁-C₈alkylsulfonyl, C₁-C₈haloalkylsulfonyl, amino, NH(C₁-C₈alkyl), N(C₁-C₈alkyl)₂, aryl or heterocyclyl, wherein aryl and heterocyclyl are optionally substituted by one or more R³⁴;
each R³³ independently is halogen, cyano, amino, nitro, hydroxyl, mercapto, C₁-C₈alkyl, C₂-C₈alkenyl, C₂-C₈alkynyl, C₃-C₈cycloalkyl, C₃-C₈cycloalkyl-C₁-C₄alkyl, C₃-C₈cycloalkyl-C₁-C₄alkyloxy, C₃-C₈cycloalkyl-C₁-C₄alkylthio, C₁-C₈alkoxy, C₃-C₈cycloalkyloxy, C₁-C₈alkenyloxy, C₂-C₈alkynyloxy, C₁-C₈alkylthio, C₁-C₈alkylsulfonyl, C₁-C₈alkylsulfinyl, C₃-C₈cycloalkylthio, C₃-C₈cycloalkylsulfonyl, C₃-C₈cycloalkylsulfinyl, aryl, aryloxy, arylthio, arylsulfonyl, arylsulfinyl, aryl-C₁-C₄alkyl, aryl-C₁-C₄alkyloxy, aryl-C₁-C₄alkylthio, heterocyclyl, heterocyclyl-C₁-C₄alkyl, heterocyclyl-C₁-C₄alkyloxy, heterocyclyl-C₁-C₄alkylthio, NH(C₁-C₈alkyl), N(C₁-C₈alkyl)₂, C₁-C₄alkylcarbonyl, C₃-C₈cycloalkylcarbonyl, C₂-C₈alkenylcarbonyl, C₂-C₈alkynylcarbonyl, wherein alkyl, alkenyl, alkynyl and cycloalkyl are optionally substituted by halogen, and wherein aryl and heterocyclyl are optionally substituted by one or more R³⁴;
each R³⁴ independently is halogen, cyano, C₁-C₄alkyl, C₁-C₄haloalkyl, C₁-C₄alkoxy or C₁-C₄haloalkoxy; and
R³⁵ is C₁-C₆alkyl, C₁-C₆alkoxy or C₁-C₆alkylcarboxy;
or a salt or a N-oxide thereof.

2. A compound according to claim 1, wherein R¹² is aryl optionally substituted by one or more R¹⁵, arylalkyl optionally substituted by one or more R¹⁵, a 7- to 11-membered isocyclic ring system optionally substituted by one or more R¹⁶′, wherein the isocyclic ring system contains at least one aromatic cycle.

3. A compound according to claim 1, wherein R¹² is phenyl optionally substituted by one or more R¹⁵, phenyl-C₁-C₄alkyl optionally substituted by one or more R¹⁵, a 7- to 11-membered isocyclic bicyclic ring system optionally substituted by one or more R¹⁶, wherein the isocyclic bicyclic ring system contains an aromatic cycle and a non-aromatic cycle.

4. A compound according to claim 1, wherein R¹² is heteroaryl optionally substituted by one or more R¹⁵, heteroarylalkyl optionally substituted by one or more R¹⁵, a 7- to 11-membered heterocyclic ring system optionally substituted by one or more R¹⁶, wherein the heterocyclic ring system contains at least one aromatic cycle,

5. A compound according to claim 4, wherein R¹² is 5-6 membered heteroaryl optionally substituted by one or more R¹⁵, 5-6 membered heteroaryl-C₁-C₄alkyl optionally substituted by one or more R¹⁵, or a 7- to 11-membered heterocyclic ring system, optionally substituted by one or more R¹⁶, containing an aromatic cycle and a non-aromatic cycle.

6. A compound according to claim 1, wherein R¹² is group C-1.

7. A compound according to claim 6, wherein R²² is hydroxyl or O⁻M⁺.

8. A compound according to claim 6, wherein C-1 is selected from groups Z-1 to Z-19.

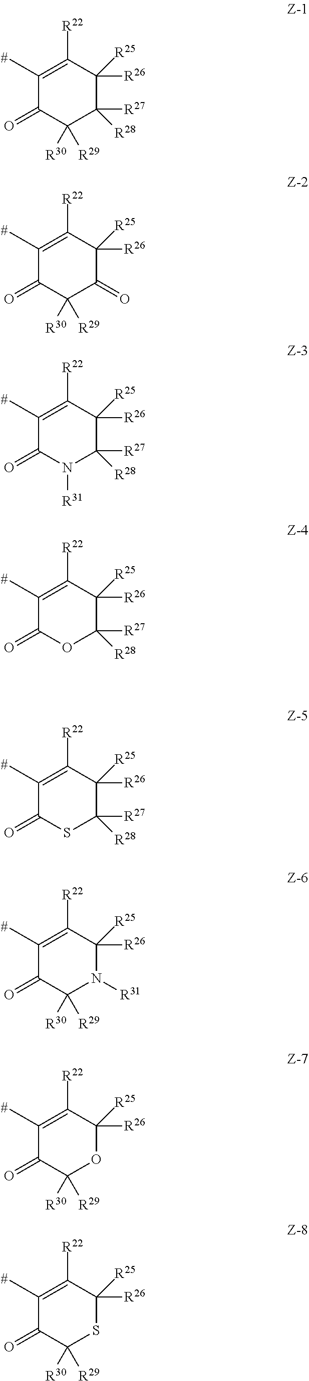

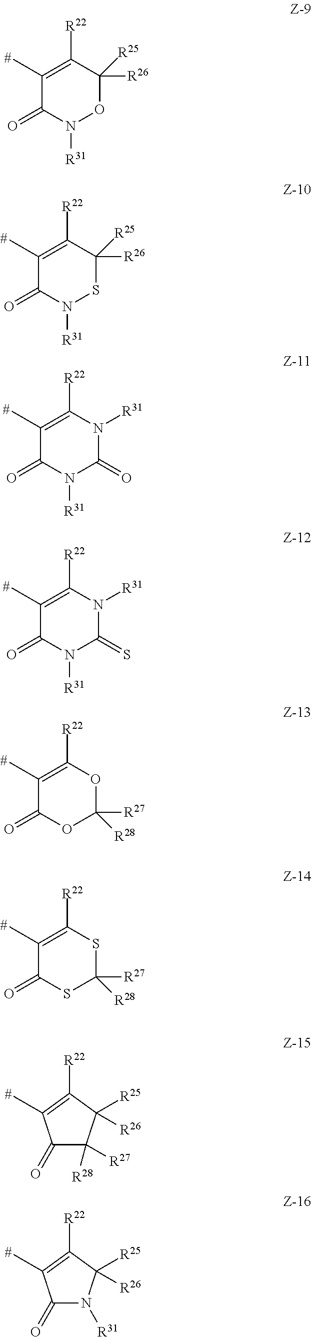

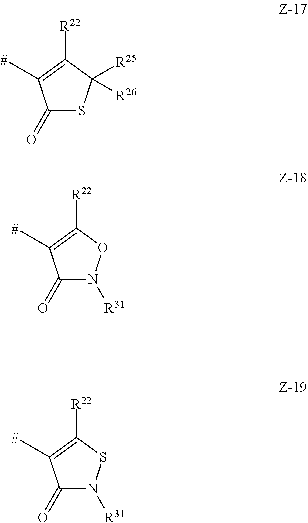

9. A compound according to claim 1, wherein R¹ and R² are independently methyl or halomethyl.

10. A compound according to claim 1, wherein R³, R⁴, R⁵, R⁶, R′, R⁸, R⁹, R¹⁰ and R¹¹ are independently hydrogen, halogen, methyl or halomethyl.

11. A compound according to claim 1, wherein G¹ and G³ are O.

12. A compound according to claim 1, wherein p is 1 and n is 2.

13. A compound of formula II: 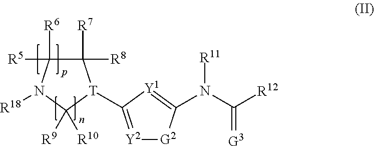
wherein R¹⁸ is hydrogen or a protecting group, and G², G³, Y¹, Y², n, p, R⁵, R⁶, R⁷, R⁸, R⁹, R¹⁰, R¹¹ and R¹² are as defined for a compound of formula I in claim 1; or a compound of formula III 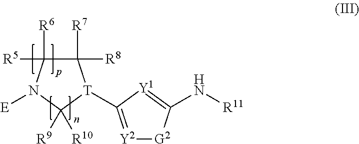
wherein E is hydrogen, a protecting group or group M 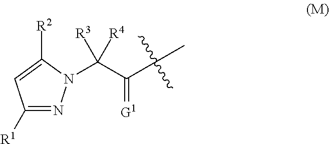
and G¹, G², T, Y¹, Y², n, p, R¹, R², R³, R⁴, R⁵, R⁶, R⁷, R⁸, R⁹, R¹⁰ and R¹¹ are as defined for a compound of formula I in claim 1; or
a compound of formula IV 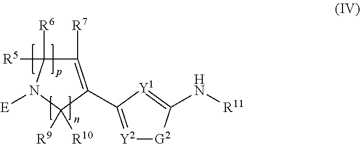
wherein E is hydrogen, a protecting group or group M 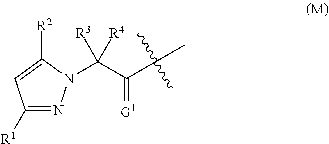
and G¹, G², Y¹, Y², n, p, R¹, R², R³, R⁴, R⁵, R⁶, R⁷, R⁹, R¹⁰ and R¹¹ are as defined for a compound of formula I in claim 1.

14. A composition comprising at least one compound as defined in claim 1 and an agriculturally acceptable carrier, optionally comprising an adjuvant, and optionally comprising one or more additional pesticidally active compounds.

15. A method of controlling or preventing an infestation of plants, propagation material thereof, harvested crops or non-living materials by phytopathogenic or spoilage microorganisms or organisms potentially harmful to man, which comprises the application of a compound as defined in claim 1, to the plant, to parts of the plants or to the locus thereof, to propagation material thereof or to any part of the non-living materials.
